(19) United States
(12) Patent Application Publication
(10) Pub. No.: US 2019/0351262 A1
(43) Pub. Date: Nov. 21, 2019

(54) NAIL METALLIZATION

(71) Applicant: LANDA LABS (2012) LTD, Rehovot (IL)

(72) Inventors: Benzion LANDA, Nes Ziona (IL); Sagi ABRAMOVICH, Ra'anana (IL); Galia GOLODETZ, Rehovot (IL); Dan AVITAL, Mazkeret Batya (IL)

(73) Assignee: LANDA LABS (2012) LTD, Rehovot (IL)

(21) Appl. No.: 16/476,293

(22) PCT Filed: Jan. 11, 2018
(86) PCT No.: PCT/IB2018/050169

§ 371 Date: Jul. 7, 2019

(30) Foreign Application Priority Data
Jan. 11, 2017 (GB) 1700478.9
Feb. 23, 2017 (GB) 1702885.3

(51) Int. Cl. A61Q 3/02; A45D 29/00

(52) U.S. Cl. CPC A61Q 3/02; A45D 31/00; A45D 29/00

(57) ABSTRACT

Methods, kits and structures are disclosed for providing a desired protective and/or visual effect to natural or artificial nails. One method comprises applying a base coat to at least part of an outer surface of the nail substrate; providing a flexible support having disposed, on a surface thereof, a monolayer of metallic-looking particles of at least one metallic-looking pigment; and transferring the monolayer from the flexible support to an outer surface of the applied base coat, so as to form a coat of metallic looking particles on the nail substrate.

### FIELD

The present disclosure relates to methods for applying pigments to a keratinous substrate or synthetic substitutes thereof In particular, the present disclosure relates inter alfa to a method providing a desired protective and/or visual effect to natural or artificial nails.

### BACKGROUND

Compositions known as nail polishes, nail varnishes or enamels and methods of using the same are known. More frequently applied at home, there also exist nail salons specializing in such products where manicurists perform the associated techniques, in particular when specific patterns are desired. Typically, the nail polishes, including the more recently commercialized nail gels, if not solvent-free, are generally based on organic solvents. These compositions generally provide for one or more of the following effects to their keratinous substrate: a) a coloring effect (e.g., a home or salon colored nail polish), b) a protective effect (e.g., a transparent nail polish reducing the occurrence or development of nail imperfections or reinforcing against brittleness); or c) a curative effect (e.g., the nail polish comprising a pharmaceutically active compound such as a fungicide or fungistatic agent). More recently, with fashion advances in nail decorations, some nail compositions (e.g., nail glues) have been developed to attach fake nails or ornamental elements, such as fake, or even real, gem stones.

Taking for instance a mammalian subject being a human, the keratinous substrate can be the external surface of finger nails or toe nails. Moreover, similar coloring effects are also desired for artificial nails, typically used for fashion purposes to extend or simply cover natural nails. These synthetic substrates, typically made of lightweight “nail-shaped” plastic forms, are glued on the end of the natural nail or over the entire nail. As used herein, a “nail substrate” encompasses both natural keratinous substrates and synthetic substrates, including gel and acrylic nails that are formed on the natural nail in situ, suitable for the formation of artificial nails.

The nail polish can be applied on such nail substrates as one or more layers, the compositions of which may vary depending on the intended use. While a single layer may suffice in most situations, it is also possible to apply a subsequent layer of the same type of polish (e.g., twice a colored nail polish) or different layers of different types of polish. The first layer directly applied to the nail may be referred to as a “base coat nail polish”. A base coat can be the only coat of nail polish applied and serve a protective purpose or a curative goal if the nail substrate is a natural nail of a living subject. Such base coats typically contain little to no pigments. A base coat may additionally improve the adherence or any other effect sought by the subsequent layer, typically being a colored nail polish. In some cases, a “Top coat nail polish” can be further applied on top of one or more coats of nail polish. Alternatively, the base coat may be the colored nail polish, a top coat being optionally provided to protect the colored nail substrate.

Generally, the layers are applied sequentially, the period of time between any two layers enabling the first layer of nail polish to at least partially harden, to at least partially cure or to at least partially dry before the second layer is applied, so as to form distinct layers in the structure formed by fully hardened or dried layers. The period of time may depend upon the composition of each of the nail polishes being sequentially applied, as well as on the thickness of the layers formed thereby. Desirably, the waiting in between two such applications steps does not exceed ten minutes, shorter time periods of less than five or two minutes being preferable. For this reason, organic solvents that are relatively volatile at ambient conditions are conventionally used.

Generally, the color effect of the colored nail polish is provided by dyes or pigments dissolved or dispersed in the polish media (e.g., aqueous or organic solvents). Such solvents, when volatile, generally raise health concern, whether as part of the conventional nail polish or as part of a nail polish remover, as such chemicals can be absorbed through skin and nails.

Moreover, their vapors can be inhaled by the subject applying the nail polish or by the subject whose nail substrates are being coated with such nail polishes.

In conventional nail polish compositions, dyes are often preferred over pigments as coloring agents. While the latter are expected to provide improved light-fastness, pigments are typically insoluble, hence more difficult to formulate into stable dispersions.

The nail coloring industry wishes to provide an increasing range of visual effects, which may include in addition or in replacement to a basic coloring of a nail substrate, special effects such as iridescence, glitter, metallic-appearance or mirror-like look, to name a few.

Such effects are typically achieved with inorganic pigments, such as metals, alloys or other materials (e.g., ceramics, silicates, bismuth oxychloride substrates and the like) coated with thin layers of such metallic substances, including oxides thereof All such pigments providing for a metallic appearance, irrespective of their own chemical class, are termed herein “metallic-looking” pigments. Such metallic-looking pigments are particles generally shaped as thin flakes having sub-micron thickness, the longest size of which in the planar dimension being generally of several micrometres (e.g., between 2 and 50 μm). However, such pigments are generally applied in a manner preventing or reducing the achievement of an ideal mirror-like effect, the flakes being generally randomly oriented with respect to the surface of the nail substrate.

### SUMMARY

The present disclosure is directed inter alfa to answer the foregoing needs for nail compositions able to provide a metallic appearance, and methods of applying the same on nail substrates, such methods and compositions overcoming some of the problems observed in the field of nail special effects.

In a first aspect of the present invention there is provided a method of providing a metallic appearance to a nail substrate, the method comprising:

a) applying a base coat to at least part of an outer surface of the nail substrate;

b) providing a flexible support having disposed, on a surface thereof, a monolayer of metallic-looking particles of at least one metallic-looking pigment; and

c) transferring the monolayer from the flexible support to an outer surface of the applied base coat, so as to form a coat of metallic-looking particles on the nail substrate.

In some embodiments, the method further comprises burnishing the metallic-looking particles adhering to the nail substrate, so as to increase the metallic appearance of the coat.

In some embodiments, the method further comprises applying a top coat to an outer or top surface of the metallic-looking particles adhering to the nail substrate.

According to another aspect of the present invention there is provided a kit for providing a metallic appearance to a nail substrate, the kit comprising:

(a) a base coat comprising:
(i) a liquid carrier;
(ii) a curable film-forming polymer adapted such that, upon full curing of the base coat, the base coat achieves a hardness in the range of 10 Shore A to 90 Shore A;
and optionally one or more of:
(iii) a dispersant able to disperse the curable film-forming polymer in the liquid carrier;
(iv) a cross-linking agent able to facilitate cross-linking of the curable film-forming polymer; and
(v) a curing accelerator or catalyst;
   wherein the base coat is capable of covering at least a selected region of the nail substrate; and

(b) a flexible support containing a plurality of metallic-looking particles disposed thereupon, the support being sufficiently flexible to follow the contour of the nail substrate upon contacting with the base coat once applied to the substrate;

wherein the metallic-looking particles on the flexible support provide a gloss value of 100 gloss units or more as measured at 20° from normal of the flexible support.

According to another aspect of the present invention there is provided an artificial nail construction comprising:

(a) an artificial nail substrate;

(b) a base coat adhering to a top surface of the artificial nail substrate;

(c) a plurality of metallic-looking particles disposed on, and adhering to, the base coat, the metallic-looking particles oriented as a monolayer. &p In some embodiments of the artificial nail construction, the monolayer imparts to, or contributes to, a gloss value measured at a top surface of the artificial nail construction, the gloss value being at least 100 gloss units, and optionally within a range of 100 to 1800, 200 to 1800, 300 to 1800, 400 to 1800, 500 to 1800, 400 to 1500, or 400 to 1200 gloss units, as measured at 20° from normal of the top surface.

In some embodiments of the artificial nail construction, the plurality of the metallic-looking particles is disposed on, and adhered to, the base coat, by transferring the plurality from a flexible support by a method as disclosed herein.

In some embodiments, the kit comprises the artificial nail construction as disclosed herein; and a nail adhesive.

In some embodiments, the kit further comprises an applicator for applying the nail adhesive.

In some embodiments, the metallic appearance of the metallic-looking particles in the selected region has a gloss value of 100 gloss units or more as measured at 20° from normal of metallized surface. Normal as employed herein in this context means perpendicular to the surface.

In some embodiments, the gloss value is within a range of 100 to 1800, 200 to 1800, 300 to 1800, 400 to 1800, 500 to 1800, 400 to 1500, or 400 to 1200 gloss units.

In some embodiments, the transferring is effected by contacting the monolayer with the outer surface and applying a relative pressure between the flexible support and the nail substrate.

In some embodiments, the monolayer is disposed on an entirety of the surface of the flexible support.

In some embodiments, the monolayer is disposed as a predetermined pattern on the surface of the flexible support.

In some embodiments, the surface of the flexible support includes a hydrophobic particle receptive surface.

In some embodiments, the method further comprises applying a top coat to the outer surface of the applied base coat so as to completely cover the monolayer. In such embodiments the monolayer may not entirely cover the base coat.

In some embodiments, the base coat consists of a curable film-forming polymer optionally having a Tg of 20° C. or less, the curable film-forming polymer adapted to form upon full curing of the base coat, a film having a hardness of at least 10 Shore A and at most 90 Shore A and being optionally dispersed in a liquid carrier.

In some embodiments, the curable film-forming polymer is selected from the group consisting of polyurethanes; acrylic polymers; vinyl polymers; polyvinyl butyrals; alkyd resins;

and resins derived from aldehyde condensation products including arylsulfonamide-formaldehyde resins, toluenesulfonamide-formaldehyde resin, aryl sulfonamide-epoxy resins and ethyltosylamide resins.

In some embodiments, the base coat further comprises a cross-linking agent, the cross-linking agent being optionally present in an amount of up to 100 wt. % by weight of the polymer, or in the range between 0.01 wt. % and 20 wt. %.

In some embodiments, the base coat further comprises a curing auxiliary, the curing auxiliary being at least one of a drying accelerator, a photo-initiator, a UV-curing accelerator and a UV-curing catalyst.

In some embodiments, the particles disposed on the flexible support are made of a material selected from the group consisting of metal, alloys and oxides thereof, and core substrate coated with any of the foregoing materials, the core substrate being of a core material selected from ceramics, silicates and plastic resins.

In some embodiments, the particles disposed on the flexible support are flake-shaped particles having a dimensionless aspect ratio (ASPavg) between the smallest average dimension of the flakes (Havg) and the longest average dimension of the flakes (Lavg) of at least 1:5 and of at most 1:500.

In some embodiments, the average longest dimension (Lavg) of the flake-shaped particles is 200 μm or less, 50 μm or less, 10 μm or less, or 5 μm or less, and optionally, at least 0.08 μm, at least 0.12 μm, at least 0.15 μm, at least 0.2 μm, at least 0.4 μm, or at least 0.6 μm.

In some embodiments, the average thickness or smallest dimension (Havg) of the flake-shaped particles is 200 nm or less, 150 nm or less, 100 nm or less, or 50 nm or less, and at least 10 nm, at least 15 nm, or at least 20 nm.

In some embodiments, the top coat consists of a top coat film-forming polymer having a Tg of 40° C. or more, wherein the film-forming polymer is adapted to form, upon full curing of the top coat, a top coat film having a hardness of at least 40 Shore D, and wherein the polymer is optionally dispersed in a liquid carrier.

In some embodiments, the top coat film-forming polymer is selected from the group consisting of cellulose-based polymers selected from the group comprising nitrocellulose, cellulose acetate, cellulose acetobutyrate, cellulose acetopropionate, and ethylcellulose; acrylic polymers; vinyl polymers; polyvinyl butyrals; alkyd resins; and resins derived from aldehyde condensation products including aryl sulfonamide-formaldehyde resins, toluenesulfonamide-formaldehyde resin, aryl-sulfonamide-epoxy resins and ethyltosylamide resins.

In some embodiments, at least one of the base coat and the top coat is tinted, so as to further provide a background and/or a foreground tint, respectively, to the metallic appearance.

In some embodiments, the applying the base coat is performed solely on a portion of the outer surface of the nail substrate.

In some embodiments, the applying the base coat is performed on an entirety of the outer surface of the nail substrate.

In some embodiments, the method further comprises curing any one of the applied coats, the curing being selected from dry curing, air-flow curing, heat curing, UV-curing, visible light curing and e-beam curing.

In some embodiments, of the kit, the particles are disposed upon the flexible support in a predetermined pattern.

In some embodiments, of the kit, the flexible support is provided in a predetermined shape dimensioned to produce a pattern solely on a portion of the nail substrate.

In some embodiments, the kit further comprises a top coat comprising:

(i) a liquid carrier;

(ii) a clear film-forming polymer having a Tg of 40° C. or more, and adapted such that, upon full curing of the top coat, the top coat achieves a hardness of at least 40 Shore D; and optionally one or more of:

(iii) a dispersant able to disperse the clear film-forming polymer in the liquid carrier;

(iv) a cross-linking agent able to facilitate cross-linking of the clear film-forming polymer;

(v) a curing accelerator or catalyst;

(vi) a wetting agent;

(vii) a levelling agent; and

(viii) a tinting agent.

In some embodiments, the kit further comprises one or more of the following:

i) an applicator for applying any of the base coat, the flexible support and the top coat to an outer surface of the nail surface or to any layer applied thereupon;

ii) a burnishing device for optional burnishing of the particles once applied on the nail substrate or on any layer applied thereupon;

iii) a nail polish remover;

iv) a curing device;

v) a nail substrate priming composition;

vi) sand paper or emery board;

vii) 2-D and/or 3-D ornamental elements;

viii) a nail adhesive;

ix) a mask dimensioned to expose a predetermined area of the nail substrate; and

x) a memory device including at least one electronic file or a printed leaflet guiding a user of the kit on the use thereof.

In some embodiments, the kit is suitable for use in a method substantially as described herein.

In some embodiments, the method comprises applying a nail adhesive on at least part of an outer surface of the nail substrate; and applying, on the nail adhesive, the artificial nail construction.

In some embodiments, the base coat, which includes or consists of a curable film-forming polymer, or at least the outer surface of the base coat, is tacky or sufficiently tacky at the time the particles are applied thereupon. The terms “tacky” and “sufficiently tacky” as used herein are not intended to mean that the base coat is necessarily tacky to the touch but only that it is soft enough to enable the adhesion of the particles to its surface. By way of non-limiting example, a surface can be sufficiently tacky by having a suitable hardness. Such an exemplary property of a surface can be obtained, for instance, by use of cross-linkable polymers, the degree of actual cross-linking allowing tailoring the hardness of the cured polymer. In some embodiments, the base coat comprises a cured polymer. In alternative embodiments, the base coat comprises a curable (i.e. pre-cured or partially cured) polymer or pre-polymer. In the latter case, curing may proceed following the application of the metallic-looking particles, either passively (e.g., spontaneous evaporation of a solvent or visible light curing) or actively (e.g., by chemically or physically triggering curing via drying, heating, ultraviolet (UV)-curing, electron beam (e-beam)-curing or any like known curing factor). Any film-forming polymer that may cure, cross-link or further polymerize by any such curing process is herein referred to as a “curable film-forming polymer”. The terms “curing”, “cross-linking” or “polymerizing”, and their respective grammatical variants, can be used interchangeably.

In some embodiments, the method further comprises a curing step following the application of any of the nail formulations and optional burnishing, the curing being either given sufficient time to passively proceed or being actively triggered by a curing agent which can be chemical, physical, or a combination of both.

Curing can be achieved, by way of example, by dry curing, air flow curing, heat curing, UV curing, visible light curing and e-beam curing. The curing method, when used for coats applied on nail substrates attached to a living subject, should be selected to be additionally safe and convenient for the subject. Hence, for example, while heat curing can be performed at relatively elevated temperatures and/or for relatively long period of times when coats are applied on artificial keratinous substrate, such parameters (e.g., temperature, duration, area targeted by heat etc.) are to be reduced to be convenient to the subject.

Some curable film-forming polymers can undergo “self-curing”, cross-linking with one another through respective cross-linkable groups without any chemical additives being necessary. Still, the addition of cross-linking agents and/or other curing auxiliary may facilitate (e.g., accelerate) the formation of a cured film. Examples of self-curable film-forming polymers include water emulsions of polyurethane acrylates (PUA), styrene acrylates and polyacrylic polymers.

Other curable film-forming polymers require the addition of cross-linking agents in order to proceed towards polymerization and formation of a cured film under appropriate curing conditions. Some curing methods can be facilitated by curing auxiliaries. For instance, dry curing (through spontaneous evaporation at ambient conditions or through air blowing) can be facilitated by the addition of a drying accelerator. Energy curing using UV-light can be facilitated by the addition of a photo-initiator (e.g., by alpha hydroxyketones).

In some embodiments, the curable film-forming polymer of the base coat has a glass transition temperature (Tg) of 20° C. or less, 0° C. or less, or −20° C. or less.

In some embodiments, the curable film-forming polymer of the base coat is adapted to form a hydrophobic base coat and/or a negatively charged base coat and/or a positively charged base coat.

In some embodiments, the base coat has a smooth outer surface when applied/dried/cured, having a roughness average (Rₐ) of 250 nanometres or less, 200 nm or less, 150 nm or less, 100 nm or less, 80 nm or less, 60 nm or less, or even 40 nm or less. Typically, Rₐ is at least 3 nm, at least 5 nm, or at least 7 nm. A smooth surface increases the gloss that can be obtained following suitable application of metallic-looking particles. Hence, in embodiments where particles are applied from a flexible support, the surfaces of relevance to the particles orientation (e.g., the outer surface of the particles' receptive layer, or of an underneath body, when present) are also preferably smooth to enable quality transfer and maximal gloss. When a matte effect is desired, the roughness of the base coat or of the surfaces of a flexible support can be greater than 250 nm as measured by Rₐ.

In some embodiments, the base coat has a hardness between about 10 Shore A and 90 Shore A when applied/dried/cured.

In some embodiments, the base coat is applied so as to cover the entire surface of the keratinous substrate (e.g., coats a finger nail in its entirety). In alternative embodiments, the base coat is applied on only part(s) of the substrate, so as to form any desired shape, whether random or predetermined. Such partial application of a base coat can be achieved by selectively “drawing” the desired shape using a non-selective applicator, by way of example a stripe can be formed by applying one or more lines with a small brush. Alternatively, the applicator can have the desired shape, for instance, being dipped into the base coat and used as a “rubber stamp” where desired on the substrate. Predetermined patterns of base coat can also be applied by using a “mask” having voids of desired shape through which the base coat can be selectively applied where desired on the nail substrate. To facilitate its positioning, the mask can advantageously be transparent.

In some embodiments, the particles are applied while being disposed on a flexible support. In this case, the particles disposed on the surface of the support are transferred to an outer surface of the base coat, or a selected region thereof, by contacting the particles with the outer surface and by pressing the flexible support and the nail substrate one against the other. The flexible support can then be peeled apart from the keratinous substrate and discarded, at least in segments from which particles would have transferred away. The surface of the flexible support upon which the particles can be disposed is termed herein the “particle receptive surface”. In some embodiments, the particle receptive surface of the flexible support is hydrophobic.

In some embodiments, the particles are disposed on the particle receptive surface of the flexible support so as to form, following contacting with the base coat on the nail substrate and transferring thereto, a substantially continuous layer of particles upon the entire surface of the base coat. When the base coat is applied on the entire surface of the keratinous substrate, the layer of particles can be formed on the full surface of the nail.

In other embodiments, the particles can be disposed on the surface of the flexible support in a predetermined pattern. In this case, the particle form, following transfer on part of the surface of the base coat, a layer of particles shaped according to a mirror-image of the predetermined pattern.

Predetermined patterns of particles can be formed on the flexible supports by any suitable method. By way of non-limiting example, particles can be applied through masks permitting application of particles in selected regions of a fully receptive support. Alternatively, masks can be used to selectively permit the adhesion of particles by previous application of a “particle receptive pattern” on a support otherwise unable to retain the particles as a transferable layer. Additionally, the flexible support can be formed or cut according to the desired transferable pattern. This alternative is only suitable for patterns of size and shape permitting the convenient peeling away of such a pre-designed flexible support.

The support needs be sufficiently flexible to follow the contour of the keratinous substrate when pressed against it, so as to permit enough contact to enable transfer of the particles. On the other hand, the support should not be too flexible, so as modify the arrangement of the particles that would result from an exceedingly flexible support that could undesirably deform during application to the base coat, during peeling therefrom or both. An example of an exceedingly flexible support would be an elastic support unable to substantially retain its original dimensions during the application and/or removal process step.

This method of indirect transfer of metallic-looking particles via a flexible support, optionally carrying a monolayer of such particles, is believed to be advantageous in a few respects. For instance, the particles can be more readily burnished on the flexible support, which can be backed by a solid plane, than on a relatively curved nail substrate, whether natural or artificial. An improved burnishing may increase the metallic appearance of the layer of particles, including following their transfer to a base coated substrate. The particles being applied on a base coat by this method may substantially remain in their relative position one to another, so that if the particles are “pre-burnished” on the flexible support, they essentially retain their relatively shiny status once transferred, providing a similar metallic appearance before and after transfer.

Another advantage of the inventive method relates to the added protection provided to the particles during their downward-facing disposition on the flexible support, up until the time of transfer. Such downward-facing disposition may protect the particles from oxidation or from any deleterious reaction caused by exposure to the environment.

In some embodiments, the particles are applied on the particle receptive surface of the flexible support in a gas stream or via a gas stream (e.g., the particles being contained in a pressurized can, being sprayed at will through an appropriate nozzle). In alternative embodiments, the particles are applied in a liquid carrier.

The base coat and the optional top coat are generally compositions including a liquid carrier, but this is not essential as some nail compositions, including a liquid composition of dispersed particles (a particles' dispersion), can be solvent free, some of their constituents being per se liquid and their combinations with their solid counterparts flowable enough to be applied as a liquid.

The liquid carrier of each of the base coat and top coat can independently be an aqueous carrier or an organic carrier, the latter being advantageously relatively volatile under ambient conditions.

In some embodiments, the carrier of any one of the liquid coats sequentially used to provide the metallic appearance to the keratinous substrate is an aqueous carrier. As used herein, an aqueous carrier consists of at least 55% water per total weight of the liquid carrier being considered. In some embodiments, the aqueous carrier contains at least 60 wt. %, at least 65 wt. %, at least 70 wt. %, at least 75 wt. %, at least 80 wt. %, at least 85 wt. %, or at least 90 wt. % water per total weight of the liquid carrier. Water suitable for such compositions include refined water, distilled water, deionized water, purified water and the like. The portion of a nail composition constituting the “liquid carrier” part, and the aqueous part therein, is generally provided by the manufacturer of such compositions. Alternatively, such proportions can be assessed by standard methods, including by way of example, by thermogravimetric analysis (TGA), preferably under inert gas atmosphere for air-sensitive pigments.

In some embodiments, the aqueous carrier further comprises water-miscible co-solvent(s), such as glycerol, propylene glycols, including monopropylene glycol (PG, having CAS No. 57-55-6), dipropylene glycol (DPG, having CAS No. 25265-71-8, such as oxybispropanol), and tripropylene glycol (TPG, having CAS No. 24800-44-0, such as [(1-methyl-1,2-ethanediyl)bis(oxy)]bispropanol), and isomers thereof. Water-miscible co-solvents, can also be selected from the group comprising ethylene glycol, diethylene glycol, polyethylene glycol (PEG), hexylene glycol, 1,2 hexane diol and isomers thereof.

In some embodiments, the carrier of any one of the liquid coats sequentially used to provide the metallic appearance to the keratinous substrate includes an organic solvent in an amount of at least 60% solvent per total weight of the liquid carrier being considered. In some embodiments, the organic solvent carrier contains at least 65 wt. %, at least 70 wt. %, at least 75 wt. %, at least 80 wt. %, at least 85 wt. %, or at least 90 wt. % solvent per total weight of the liquid carrier.

Suitable organic solvents are those which are liquid at ambient temperature and include, but are not limited to: ketones such as methyl ethyl ketone, methyl isobutyl ketone, diisobutyl ketone, isophorone, cyclohexanone or acetone; alcohols, such as ethanol, isopropanol, diacetone alcohol, 2-butoxyethanol or cyclohexanol; glycols, such as ethylene glycol, propylene glycol, pentylene glycol or glycerol; propylene glycol ethers, such as propylene glycol monomethyl ether, propylene glycol monomethyl ether acetate or dipropylene glycol mono(n-butyl) ether; short-chain esters (having a total of 2 to 7 carbon atoms), such as ethyl acetate, methyl acetate, propyl acetate, n-butyl acetate or isopentyl acetate; alkanes, such as decane, heptane, dodecane or cyclohexane; aldehydes, such as benzaldehyde or acetaldehyde; and their mixtures, as long as compatible in relative proportions resulting in a liquid miscible combination.

In some embodiments, the particles can be applied in powder form, in absence of a fluid (gas or liquid) carrier. For instance, the particles in powder form can be gently rubbed (e.g., with a soft cloth) or brushed over the outer surface of a base coat. In some cases, the particles in powder form can be applied by dipping the nail substrate into the powder. In these cases, the particles can be further treated (e.g., coated) to maintain the flowability of the powder form, in addition to the effects generally sought by any further coating of the particles independently of form (e.g., increased affinity to adjacent layer(s), decreased corrosion, etc.).

Independently of the fluid within which the particles are suspended, or lack thereof if in powder form, following their application to a tacky base coat, particle receptive layer of a flexible support, or outer surface thereof, the metallic-looking particles form a layer, which depending on the application method elected and the desired visual effect, can be substantially continuous or patterned with respect to the base-coated surface or the flexible support.

As the layer of metallic-looking particles applied to the base coat or flexible support outer surface is made up of a mosaic of individual particles, the proportion of the outer surface covered with particles in any segment set to be continuous will be less than 100% on account of the interstices between the individual particles. Depending on the desired visual effect, and among other things on the type of base coat, particles, top coat, or burnishing step, if any, including by way of example whether the base coat and/or top coat are further tinted, the proportion of the base coat surface that should be covered with the metallic-looking particle to form a substantially continuous layer may vary. In some embodiments, this proportion of coverage may only be 95%, or 90%, or 85%, or 80%, or 75%, or 70% or even 65% or less. The acceptable proportion of particles deemed to form a substantially continuous layer therefore depends on the ability to visually detect discontinuities that would be perceived as a defect from the standpoint of the desired visual effect.

In further embodiments, the transferred layer of metallic-looking particles (e.g., from a flexible support), whether continuous or patterned, is substantially a monolayer.

In some embodiments, the metallic appearance is estimated by the naked eye with reference to an ideal mirror. In one embodiment, the metallic appearance of the coated nail substrate is substantially a mirror-like appearance. In an exemplary embodiment, the metallic appearance or mirror-like appearance of the coated nail substrate is measured by applying in a similar manner a same sequence of same compositions on a flat substrate to reduce or eliminate measurement variations that may result from the shape of the nail substrate. This method can be called the ex situ (or ex vivo) method. In an alternative embodiment, the metallic appearance or mirror-like appearance of the coated nail substrate is assessed in situ, when the nail substrate, whether natural or artificial, typically displays a curved lateral cross-section.

In other embodiments the metallic appearance is measured using a gloss meter, the gloss meter being positioned so as to provide controlled incident illumination and collect rays reflected therefrom on a segment of the nail substrate being predominantly flat, the curvature between two points at the opposite edges of such a segment being less than 2°, if in situ method, or from a flat substrate substitute, if ex situ method.

The segment of the nail substrate coated with metallic-looking particles (e.g., flakes) according to any of the present teachings can for simplicity be referred to as the “metallized segment” or the “metallized region”. Gloss values of at least 100 gloss units in the metallized segment(s) are deemed to define a suitable metallic appearance. As the gloss values increase, the metallic appearance progresses from a relatively matte effect towards a more shiny, mirror-like, effect. In some embodiments, the gloss value in the metallized segment(s) is 150 gloss units or more, 200 gloss units or more, 250 gloss units or more, 300 gloss units or more, or 350 gloss units or more. When particularly shiny effects are desired, in such embodiments, the gloss value in the metallized segment(s) can be of 400 gloss units or more, or at least 500 gloss units, or at least 600 gloss units, or at least 700 gloss units, or at least 800 gloss units. Generally, gloss values do not exceed 1500 gloss units. The gloss value of a metallized segment is typically measured with an incident ray at 20° from the normal to the surface being studied.

As gloss may depend, in part, on the proper orientation of flake shaped pigments on a substrate, relatively thinner pigments are expected to assume parallel orientation more readily than relatively thicker pigments. Assuming for instance a metal flake and a mica flake coated with a metallic surface, both pigments surface providing a similar gloss, the gloss of a surface coated with the metal pigment having hypothetically a thickness of 50 nm will be greater than the gloss of a surface coated with the mica pigment having hypothetically a thickness of 500 nm (i.e. relatively less amenable to efficient burnishing).

In some embodiments, the metallized segment displays a relatively low haze. When measured on a log scale with an incident ray at 20° from normal, the haze can be of 500 haze units or less, 400 haze units or less, 300 haze units or less, 200 haze units or less, 150 haze units or less, 100 haze units or less, or 50 haze units or less.

In yet another embodiment, the method further comprises attaching an ornamental element, typically, but not necessarily, following the application of the metallic-looking pigment particles to the nail substrate. The ornamental elements, which can be for instance natural gemstones and more likely synthetic reproductions of precious stones or any such minute 2-D or 3-D decorative accessory, can be removably attached to the nail substrate in the metallic-looking regions of the surface of the substrate or conversely in the non-metallic-looking regions or in any area. The ornamental elements, which typically protrude above their surface of attachment (their base), can be attached via the top coat, if present. In this case, the elements can be positioned through their base where desired on the top coat when tacky, the attachment being secured by the curing of the top coat. Alternatively, a nail glue can be applied on the base of the ornamental element and the element glued where desired. Nail glues, including curable ones, are known and need not be further detailed herein. Such glues permit the transient attachment of such decorative accessories and their removal, when desired.

In some embodiments, the metallic-looking pigment particles are applied in a predetermined shape which includes a void area corresponding to a base of an ornamental element to be later attached. In this case, the “void base” area may serve as relative recess for the subsequent insertion of the desired ornamental element.

In some embodiments, the base coat and /or the top coat can be further tinted. If the tints used for any two such nail compositions differ, the underlying coat can be said to form a background color (or a background image if any particular pattern) and the overlying coat can be said to form a foreground color (or foreground image if any specific shape). When dyes and/or pigments are added to tint a nail composition, are also typically added dispersants to suitably disperse the coloring agents (e.g., forming an homogeneous coloration). When pigments are added, dispersants are required, when dyes are added, additional dispersants may not be necessary to dissolve in the nail composition being considered.

In another aspect, the disclosure provides kits including nail compositions suitable to implement the herein disclosed methods.

In a further aspect, the disclosure provides nail substrates prepared according to the herein disclosed methods and/or using the herein disclosed related kits.

These and additional benefits and features of the disclosure will be better understood with reference to the following detailed description taken in conjunction with the figures and non-limiting examples.

### BRIEF DESCRIPTION OF THE DRAWINGS

Some embodiments of the disclosure will now be described further, by way of example, with reference to the accompanying figures. The description, together with the figures, makes apparent to a person having ordinary skill in the art how some embodiments of the disclosure may be practiced. The figures are for the purpose of illustrative discussion and no attempt is made to show structural details of an embodiment in more detail than is necessary for a fundamental understanding of the disclosure. For the sake of clarity and convenience of presentation, some objects depicted in the figures are not necessarily shown to scale.

In the Figures:

FIG. 1 is a top view of a schematic representation of a human finger with a nail substrate attached thereto.

FIG. 2 is a cross-sectional view of the nail substrate along line X-X of FIG. 1.

FIGS. 3-5 are cross-sectional views of the nail substrate as shown in FIG. 2, each illustrating different layers disposed thereon, according to exemplary embodiments of the present invention.

FIG. 6 is a top view of a nail substrate partially coated with a metallic-looking layer of particles according to some embodiments of the present invention.

FIG. 7 is a top view of a nail substrate entirely coated with a metallic-looking layer of particles according to some embodiments of the present invention.

FIG. 8A is a top view of a nail substrate, and FIG. 8B shows a flexible support bearing predetermined shapes formed of metallic-looking particles according to some embodiments of the present invention.

FIG. 8C provides a cross-sectional view of a flexible support bearing a continuous layer or monolayer of metallic-looking particles, for transferring to the nail or to the artificial nail, according to various embodiments of the present invention.

FIG. 9A is a top view of a nail substrate following contact with the flexible support of FIG. 8B and transfer of predetermined shapes of metallic-looking particles from the flexible support to the nail substrate, according to embodiments of the present invention.

FIG. 9B shows the flexible support of FIG. 8B, devoid of metallic-looking particles, subsequent to the transfer.

FIG. 10 is a side view of a nail substrate partially coated with a metallic-looking layer of particles and including various metallized regions, the metallic-looking particles applied according to exemplary embodiments, the nail substrate having further attached on its outer surface ornamental elements according to some further embodiments of the present invention.

FIG. 11 is a cross-sectional view of an artificial nail construction in which a monolayer of metallic-looking particles is fixedly adhered onto a (top) surface of an artificial nail substrate.

### DETAILED DESCRIPTION

Before explaining at least one embodiment in detail, it is to be understood that the disclosure is not necessarily limited in its application to the details of construction and the arrangement of the components and/or methods set forth herein. The following detailed description, including the materials, methods and examples, are merely exemplary of the disclosure, and are intended to provide an overview or framework to understanding the nature and character of the invention, and are not intended to be necessarily limiting.

The disclosure as herein detailed and illustrated in the figures is capable of other embodiments or of being practiced or carried out in various ways as will be readily apparent to those skilled in the art without undue effort or experimentation. Various features and sub-combinations of embodiments of the disclosure may be employed without reference to other features and sub-combinations. The phraseology and terminology employed herein are for descriptive purpose and should not be regarded as limiting.

### Overall Description of an Exemplary Nail Metallizing Method

It is noted that for the sake of clarity and convenience of presentation, some layers or elements depicted in the figures described below are not necessarily shown to scale.

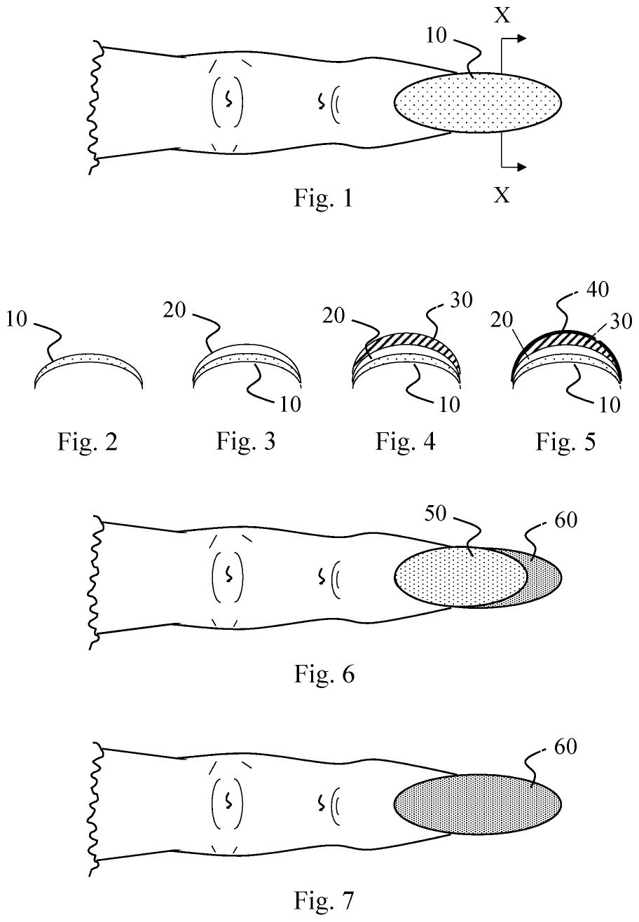

FIG. 1 shows a top view of a nail substrate 10, illustrated by way of example in the figure as a human finger nail. FIG. 2 is a cross-sectional view of the nail substrate along line X-X of FIG. 1 schematically illustrating the native nail substrate 10 before any nail composition is applied thereto.

FIG. 3 schematically illustrates a base coat 20 disposed on top of nail substrate 10. As the figure shows solely a cross-sectional view of the nail substrate, it should be emphasized that the base coat 20 may optionally be applied on only part of the nail substrate (e.g., at the tip of the nail and any other like desired location).

FIG. 4 schematically illustrates a layer of metallic-looking particles, which for simplicity can be interchangeably referred to as a metallic-looking coat 30, disposed on top of the outer surface of base coat 20, distal from nail substrate 10. The figure showing a cross-sectional view of the nail substrate, the metallic-looking coat 30 can be applied on only part of the nail substrate (i.e., on the portions where a base coat 20 was pre-applied). The metallic-looking particles can optionally be burnished following their application to the base coat. As used herein, the term burnished refers to any method capable of increasing the gloss of the metallic-looking coat 30. By way of non-limiting example, and assuming the metallic-looking particles are shaped as flakes, such improvement in relative gloss (when desired) can be achieved by increasing the proportion of flakes being oriented substantially parallel to the surface of the nail substrate. For this purpose it is therefore preferable that the base coat on which the particles are to be applied also form a layer, the outer surface of which would generally follow the contour of the underneath nail substrate. Advantageously, the base coat 20 can mask certain imperfections on the surface of the nail substrate, if present, providing in some embodiments a smooth outer surface facilitating the desired orientation of the metallic-looking flakes in metallic coat 30.

Burnishing can be achieved or improved, if so desired, for instance, by rubbing the particles with a smooth cloth, such action further expected to improve conformation of the metallic-looking particles to the nail substrate and to enhance adhesion of the metallic-looking particles to the outer surface of the base coat.

Particles may be “pre-burnished” on the flexible support prior to transfer. Moreover, the rubbing on the back side of the support to ensure proper contacting of the particles with the base coat, where such an overlap exists, is believed to provide a further partial burnishing of the particles on the base coat.

FIG. 5 schematically illustrates how in some embodiments an optional top coat 40 may be disposed on the outer surface of metallic-looking coat 30, distal from nail substrate 10. Substantially as described hereinabove, metallic-looking coat 30 may optionally be applied on only part of the nail substrate (i.e., on the portions where a base coat 20 was pre-applied). As previously mentioned, the top coat 40 can be applied only on parts of the nail substrate (or latest coat thereupon) bearing a metallic-looking coat 30, however this need not be the case, as the base coat 20 and the top coat 40 can be applied on larger areas of the nail and on the entire nail substrate, if desired.

FIG. 6 is a top view of a nail substrate partially coated with a metallic-looking layer of particles according to some embodiments. Segment 60 illustrates a “metallized” part of the nail substrate, while segment 50 represents the “non-metallized” counterpart. As above-explained, while not being visible in a top view, a “metallized” nail segment may comprise in a cross-sectional view, in addition to its nail substrate 10, a base coat 20, a metallic-looking coat 30 (the particles thereof being optionally burnished post-application) and, if desired, a top coat 40. The non-metallized nail segment 50 can be the bare nail substrate 10, or the nail substrate coated with base coat 20, or the nail substrate coated with top coat 40, or the nail substrate coated with both a base coat 20 and a top coat 40.

FIG. 7 is a top view of a nail substrate schematically showing an alternative embodiment wherein the entire surface of the nail substrate can be coated with a metallic-looking layer of particles, the metallized segment 60 thus covering all of the substrate.

While not being shown in the afore-described figures, any of the coats, layers or metallic-looking particles can be applied with a small brush, spatula, cloth, sponge, or rubber, and any like suitable devices known to the skilled person as applicators, which need not be further detailed herein. As mentioned, such applicators can be used in a non-selective manner, i.e. to coat the entire surface of the nail substrate, or in a more selective manner to coat desired segments thereof. For selective application of a base coat, applicators having a predetermined shape can be used, or regular applicators can be used in combination with masks suitable to form the desired predetermined shape.

When an improved metallic appearance is desired, the applicator may be advantageously adapted to provide smooth and/or thin layers of base coat and/or top coat. Such relatively smooth and/or thin layers are deemed beneficial for the satisfactory orientation of the transferred particles on the substrate so as to increase their gloss. For this purpose, rubber-tipped applicators and brushes may be preferable.

For instance, most such nail formulations are typically provided in individual vessels, the cap of which usually including a brush-type of applicator, that can be dipped into the formulation at will. But alternative applicators exist, by way of example, applicators equipped with at least a liquid storing part and an applying member, the nail formulation being transported from the liquid storing part to the applying member by virtue of capillary force (e.g., a pen like applicator) or applicators having a predetermined shape which can be used as “rubber stamps”.

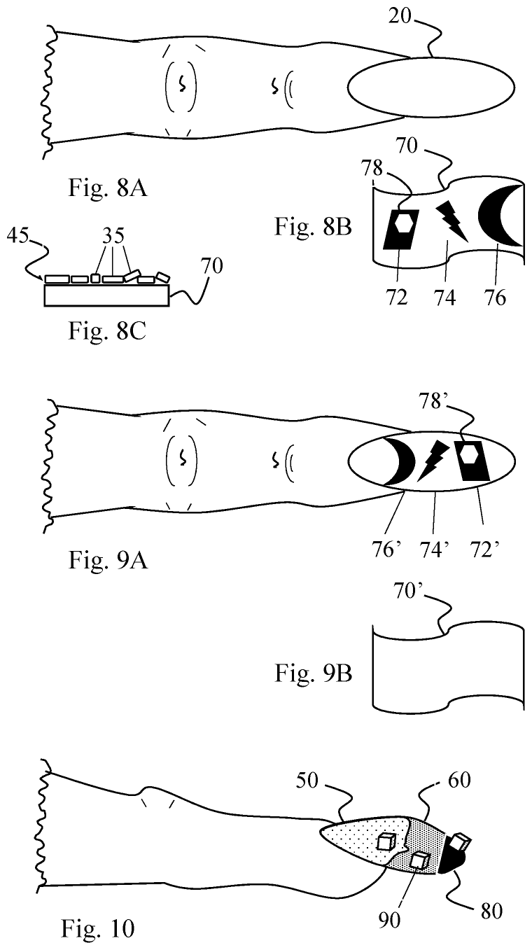

FIGS. 8A-8C provide schematic illustrations of an application method. FIG. 8A shows a top view of a nail substrate upon which a base coat 20 has been applied. FIG. 8B provides a top view of a flexible support 70 bearing predetermined shapes 72, 74 and 76, formed of metallic-looking particles. Alternatively or additionally, flexible support 70 may bear an array of predetermined, identical shape, formed of metallic-looking particles. Alternatively or additionally, flexible support 70 may bear a continuous layer of metallic-looking particles. A cross-sectional view of such a flexible support 70 bearing a continuous layer or monolayer 45 of metallic-looking particles 35 is provided in FIG. 8C.

Furthermore, while shapes 74 and 76 are continuous, shape 72 illustrates an alternative wherein the shape can include one or more voided shapes, schematically represented in the figure by 78. In some embodiments, the void 78 of a shape transferrable from a flexible support can serve once transferred to a nail substrate for the further attachment of a 2-D or 3-D ornamental element.

FIGS. 9A and 9B schematically illustrate how following contact between the nail substrate and the base coat 20 thereupon and the subsequent peeling off the flexible support, the predetermined shapes of metallic-looking particles shown as 72, 74 and 76 in FIG. 8B transfer onto the nail. As shown in FIG. 9A, mirror images 72′, 74′ and 76′, can be formed on the substrate following transfer, leaving the flexible support 70′ (of FIG. 9B) accordingly depleted of the transferred shapes and particles. 78′ schematically represents the mirror image of void 78 of shape 72. While 78′ can by itself serve for the intended visual effect, in some embodiments, it can additionally serve for the further attachment of a 2-D or 3-D ornamental element at least on part of the surface of the void.

One advantage of the inventive method relates to the added protection provided to the particles during their downward-facing disposition on the flexible support, up until the time of transfer. Such downward-facing disposition may protect the particles from oxidation or from any deleterious reaction caused by exposure to the environment.

FIG. 10 schematically illustrates on a side view of a nail substrate how ornamental elements 90, illustrated in the figure for visibility as cubes, can be further attached through or upon the outermost layer that could have been previously applied to the substrate. In one segment of the nail substrate, the ornamental element 90 is positioned on a non-metallized portion 50 of the nail. In another segment, the ornamental element 90 is positioned on the metallized portion 60 of the nail. In a last illustrated segment, the ornamental element 90 is positioned on a transferred shape 80. In the latter case, while not visible in the figure, the ornamental element 90 can be optionally attached to the underlying substrate via a void in shape 80.

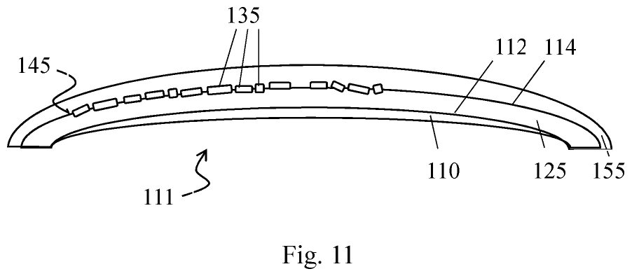

Another aspect of the present invention pertains to an artificial nail construction. FIG. 11 provides a cross-sectional view of an exemplary artificial nail construction 111 in which a monolayer 145 of metallic-looking particles 135 is fixedly adhered onto an artificial nail substrate 110. Monolayer 145 may be partially embedded within a polymeric adhesive coating or base coat 125 adhering to top surface 112 of artificial nail substrate 110. Advantageously, monolayer 145 of metallic-looking particles 135 is disposed onto top surface 114 of the base coat 125. In the exemplary embodiment illustrated in FIG. 11, an adherent top coat 155 is disposed over monolayer 145.

It is noted that because both base coat 125 and top coat 155 may be formed of similar polymeric materials, top surface or interface 114 may not be distinguishable or easily distinguishable, such that monolayer 145 may appear to be simply submerged in polymeric material.

Monolayer 145 may be partially embedded within polymeric adhesive coating 125 or may be formed upon its outer or top surface 114, substantially as described hereinabove, by applying base coat 125 to top surface 112 of artificial nail substrate 110, curing or drying the base coat, if desired, and subsequently, transferring a layer of metallic-looking particles from flexible support 70 (shown above) onto the applied (and optionally cured or dried) base coat 125.

Monolayer 145 may impart, or contribute to, a high gloss value for the artificial nail construction 111. Typically, the gloss value is at least 100 gloss units, and more typically, within a range of 100 to 1800, 200 to 1800, 300 to 1800, 400 to 1800, 500 to 1800, 400 to 1500, or 400 to 1200 gloss units, as measured at 20° from normal of the metallized surface.

### Base Coat

The base coat nail care composition typically includes one or more resins known as curable film-forming polymers. As used herein, the term “curable film-forming polymer” means a polymer that is capable, by itself or in the presence of a cross-linking agent and/or an auxiliary curing / film-forming agent, of forming a continuous film that adheres to a keratinous substrate, such as a mammalian nail.

Examples of film-forming polymers that may be used in the composition of the present disclosure include, but are not limited to, free-radical synthetic polymers, polycondensate synthetic polymers, polymers of natural origin, and mixtures thereof.

In one embodiment, the curable film-forming polymers of the base coat are polyurethanes; acrylic polymers; vinyl polymers; polyvinyl butyrals; alkyd resins; and resins derived from aldehyde condensation products such as arylsulfonamide-formaldehyde resins, for instance toluenesulfonamide-formaldehyde resin, arylsulfonamide-epoxy resins, and ethyltosylamide resins.

Suitable base coat film-forming polymers are capable of forming on the nail substrate a coat or layer having, after curing, a hardness in the range of 10 Shore A to 90 Shore A. Base coats having a hardness of less than 10 Shore A are expected to be unable to resist abrasion, as typically encountered in conventional exposure of nail substrates to daily prospectively abrading factors (e.g., washing of hands). Moreover, such relatively soft base coats may not sufficiently maintain orientation of metallic-looking particles suitable for the desired metallic appearance (e.g., flakes being substantially parallel to the substrate).

Base coats having a hardness of more than 90 Shore A are expected to be either relatively too hard to properly adhere the particles, or too brittle, or both.

Except when base coat compositions are free of any added carrier, the film-forming polymer forming substantially all of the base coat composition; the film-forming polymers are typically present in a base coat composition in an amount of 10 wt. % to 50 wt. % of the total base coat composition. In some embodiments, the curable film-forming polymer is present in the base coat in an amount in the range of 10-40 wt. %, 10-30 wt. %, or 10-20 wt. % of the total weight of the base coat composition.

When present, cross-linking agents adapted to cross-link the film-forming polymer of a base coat are in an amount of 50 wt. % to 200 wt. % of the weight of the targeted cross-linkable polymer, typically in an amount of 70 wt. % to 130 wt. % of the polymer, the cross-linking agents being in particular embodiments present in equivalent amount (i.e. 100 wt. %). When appropriate, the base coat may further comprise curing auxiliary agents. When present, such agents (e.g., photo-initiators, drying accelerators, curing accelerators or catalysts, etc.) can be in an amount of 0.1 wt. % to 20 wt. % of the total base coat composition.

Base coats can be applied in one or more layers.

Depending on the type of curable film-forming polymer used for the base coat composition, base coats can be cured by dry curing, namely simple evaporation of liquid whether spontaneous under ambient conditions or facilitated by air blowing and the like. Base coats can be alternatively and additionally be cured by any curing method adapted to cure the curable polymer. In some embodiments, the duration of curing does not exceed 10 minutes, such period preferably being of few minutes and advantageously of no more than two minutes or one minute.

Appreciably some curable film-forming polymers and their adapted curing methods permit curing periods of 60 seconds or less, 50 seconds or less, 40 seconds or less, 30 seconds or less, 20 seconds or less, 15 seconds or less, or 10 seconds or less.

When considering light-curable film-forming polymers or their relevant photo-initiators, their adapted curing methods need not only be “light-curing” processes, but also adjusted to the relevant wavelength. For instance, some UV-curable polymers or photo-initiators may cross-link as a result of a relatively narrow spectrum of wavelengths in the ultraviolet range, while other polymers and initiators may cure when subjected to any wavelength in a relatively broad spectrum. Similarly, from the standpoint of the curing method, some UV-curing lamps (and devices accordingly equipped) may provide either wavelength specific radiation or broader spectra of wavelengths. The persons skilled in the art of curable film-forming polymers readily appreciate which cross-linkable polymers are adapted to which curing method, and vice versa.

Base coat can be directly applied to the nail substrate, however, in some embodiments, the nail substrate can be pre-treated before application of the base coat, for instance in order to improve its adhesion with the pre-treated substrate. Pre-treatment can be physical, such as lightly abrading the surface of the substrate (e.g., with sandpaper), or can be chemical, such as applying a priming nail formulation.

### Metallic-Looking Particles

Metallic-looking particles can be made of at least one metal selected from the group consisting of aluminum, chromium, copper, gold, magnesium, molybdenum, nickel, palladium, platinum, silver, titanium, tin and zinc, combinations of such metals being termed alloys. Exemplary alloys include bronze, steel, brass and the like. Metallic particles can also include oxides of the foregoing, such as alumina, cerium oxide, chromium oxide, chromium hydroxide, cobalt titanate, iron oxide, titanium dioxide, zinc oxide and zirconia, to name a few.

Moreover, metallic-looking particles can be inorganic pigments made of a core substrate coated by any of the previously detailed metallic materials. The core substrate of such pigments can be a ceramic material, such as mica, a silicate material, such as glass, a plastic material, such as an acrylic, polyester, or polyurethane resin, or a bismuth oxychloride substrate. Such substrates are further coated with a thin metallic film, typically a metal oxide, which provides to these particles their visual effect. The metal oxide film may be a single film, or may be a film having a multi-layer structure. By suitably adjusting the thickness of the metal oxide film, the external appearance of the metallic-looking particles can be changed through interference of reflected light and the particles can be given a subtle change of color. Non-limiting examples of these metallic-looking inorganic pigments include titanium-oxide-coated mica, titanium-oxide-coated bismuth oxychloride, bismuth oxychloride, and tinted versions of the same.

Tinted inorganic pigments include, for example, carmine-titanium dioxide coated mica, prussian blue-titanium dioxide coated mica, black iron oxide-titanium dioxide coated mica, black iron oxide-carmine-titanium dioxide coated mica, black iron oxide-prussian blue-titanium dioxide coated mica, prussian blue-titanium dioxide coated mica, iron oxide red-coated mica, iron oxide red-titanium dioxide coated mica, iron oxide red-carmine-titanium dioxide coated mica, iron oxide red-black iron oxide-titanium dioxide coated mica, iron oxide red-prussian blue-titanium dioxide coated mica, iron oxide red-black iron oxide-prussian blue-titanium dioxide coated mica and the like.

Particles providing a metallic appearance, while not being necessarily made of metal as principal component, are sometimes also termed special-effects pigments.

As used herein, the term “metallic-looking particles” encompass all particles providing for a visual effect (e.g., luster, shine, glitter and like effects) typically associated with metals, independently of the chemical composition of the particles (i.e. including both particles having a metal, alloy or oxide thereof as principal component and particles having a distinct core substrate only coated by such metallic materials).

The metallic-looking particles as used in the methods, kits and compositions herein disclosed can be of at least one of the afore-mentioned types of particles or can be a mixture of different types, allowing achieving a wide range of visual effects.

In some embodiments, the metal-looking particles adhere to the base coat more strongly than they do to one another. This results in an applied layer that is substantially a monolayer of individual particles. Stated differently, the layer is only one particle deep over a major proportion of the area of the base coat and most, if not all, of the particles have at least some direct contact with the base coat outer surface.

Taking, for example, a platelet shaped particle contacting the base coat outer surface over most of its planar face (e.g., being substantially parallel to the surface), the resulting thickness of the monolayer (in the direction perpendicular to the surface) would approximately correspond to the thickness of the particle. If the particles have a globular shape, then the thickness of the monolayer will be commensurate with the diameter of the approximate sphere. Hence the average thickness of a monolayer of particles applied on a base coat can be approximated by the average thickness or equivalent diameter of the individual particles forming it, depending on their shape.

However, as there could be partial overlaps between adjacent particles, the thickness of the monolayer can also amount to a low multiple of the dimension of the constituting particles, depending on the type of overlap, for instance on the relative angles the particles may form with one another and/or with the base coat surface and/or the extent of the overlap and/or the extent of packing etc. A monolayer may therefore have, in only some regions, a maximum thickness (T) corresponding to about one-fold, or about two-fold, or about three-fold, or any intermediate value, of a thinnest dimension characteristic to the particles involved (e.g., up to three-fold Havg, which can the thickness of the particles for flake shaped ones).

The creation of the monolayer occurs for the same reason that an adhesive tape, when used to pick up a powder from a surface, will only pick up one layer of powder particles. When the adhesive tape is fresh, the powder will stick to the adhesive until it covers the entire tape surface. However, once the adhesive has been covered with powder, the tape cannot be used to pick up any more powder because the powder particles will not stick strongly to one another and can simply be brushed off or blown away from the tape. Similarly, the monolayer herein is formed from the particles in sufficient contact with the base coat surface and is therefore typically a single particle thick. Contact is considered sufficient when it allows the particles to remain attached to the base coat surface at least until the performance of a subsequent step and preferably following any such step, e.g., drying of the base coat, burnishing of the layer of particles, application of a top coat, or any other like step that is described in more detail herein.

Though the monolayer is believed to be formed essentially from particles in direct contact with the base coat surface, some particles may become tightly packed by adjacent particles and might remain part of the monolayer, by way of example following burnishing, even if not in direct contact with the base coat surface, possibly mildly protruding from the layer. In some embodiments, in any portion or field-of-view, the percentage of particles having no direct contact with the base coat outer surface out of the number of particles being in contact with this surface is of 15% or less, or of less than 10% or even of less than 5%.

In some embodiments, that is typically, the particles do not form a patterned monolayer. That is, while the particles can be laid down in a particular design (i.e. shape), there is no pattern within that shape. Put another way, the particles form a uniform layer that appears essentially consistent.

The metallic-looking particles can be further coated. The coating of the particles, which can be applied by physical but more typically chemical procedures, can, among other things, reduce or prevent the particles sticking to one another (e.g., as achievable with anti-caking agents and the like), increase the repulsion between the particles (e.g., as achievable by increasing the charge of the particles), protect the particles from undesired chemical modification (e.g., reduce, prevent or delay the oxidation of metals and alloys or any other deleterious aging of the metal-looking particles) or further increase the affinity of the particles to the base coat or to the top coat, as desired (e.g., modify the relative hydrophobicity, surface energy, charge, polarity of the particles with respect to one another or the coat being considered).

As particles' coats providing for a visual effect have been discussed (e.g., metal oxides on mica core), additional examples of further coats include i) an unmodified or modified carboxylic acid or fatty acid, the carboxylic acid selected from the group comprising, but not limited to, stearic acid, palmitic acid, behenic acid, benzoic acid, and oleic acid; ii) an oily substance selected from the group comprising, but not limited to, vegetal oils, such as linseed oil, sunflower oil, palm oil, soya oil, and coconut oil; mineral oils and synthetic oils; and iii) polymers such as polyacrylates, which can additionally include a dye or an inorganic or organic absorption pigments providing a tint to the underlying particles.

The coat of the particles, depending on the type of coat and kind of particles, can constitute up to about 20% by total weight of the coated particles. For instance, if metallic-looking particles are coated with a fatty acid, the carboxylic coat could be up to 20 wt. % of the fatty acid coated particles. Coats can form 15 wt. % or less, 10 wt. % or less, 5 wt. % or less, 2.5 wt. % or less, or 1 wt. % or less, of the total weight of the coated particles.

Depending on their morphology, particles (e.g., metallic-looking particles, sub-micronic (absorbing) pigments able to tint present compositions, powders carrying desired particles, and the like) may be characterized by their length, width, thickness, diameter, or any such representative measurement of their X-, Y- and Z-dimensions. Typically such sizes are provided as average of the population of particles being considered and are provided by the manufacturer of such materials. These sizes can be determined by any technique known in the art, such as microscopy and Dynamic Light Scattering (DLS). In DLS techniques, the particles are approximated to spheres of equivalent behavior and the size can be provided in terms of hydrodynamic diameter. DLS also allows assessing the size distribution of a population. As used herein, particles having a size of, for instance, 1 μm or less, have at least one dimension equal to or smaller than 1 μm, and possibly two or even three, depending on shape.

Though not essential, the particles of any particular kind may preferably be uniformly shaped and/or within a symmetrical distribution relative to a median value of the population and/or within a relatively narrow size distribution for this particular kind.

A particle size distribution (PSD) is said to be relatively narrow if at least one of the two following conditions applies:

A) the difference between the hydrodynamic diameter of 90% of the particles and the hydrodynamic diameter of 10% of the particles is equal to or less than 150 nm, or equal to or less than 100 nm, or equal to or less than 50 nm, which can be mathematically expressed by: (D90−D10)≤150 nm and so on; and/or

B) the ratio between a) the difference between the hydrodynamic diameter of 90% of the particles and the hydrodynamic diameter of 10% of the particles; and b) the hydrodynamic diameter of 50% of the particles, is no more than 2.0, or no more than 1.5, or no more than 1.0, which can be mathematically expressed by: (D90−D10)/D50≤2.0 and so on.

D10, D50 and D90 can be assessed by number of particles in the population, in which case they may be provided as D_{N}10, D_{N}50 and D_{N}90, or by volume of particles, in which case they may be provided as D_{V}10, D_{V}50 and D_{V}90. The foregoing measurements can be obtained by DLS techniques when the samples to be studied are suitably fluid or by microscopy when the particles under study are in dry form. As used herein, D50, which can also be termed the “average measured particle size” or simply the “average particle size” may refer, depending on the measuring method most suited to the particles being considered and their media, either to D_{V}50 (by DLS and the like) or to the volume average size of particles found in a field of view of a microscope adapted to analyze in the scale of the particles. D90 accordingly relate to measurements applying to 90% of the population under study, thus also termed the “predominant measured particle size” or simply the “predominant particle size” which can for instance be assessed by DLS techniques as D_{V}90.

As mentioned above, such relatively uniform distribution may not be necessary for certain applications. For instance, having a relatively heterogeneously sized population of metallic-looking pigment particles may allow, in a coating formed thereby, relatively smaller particles to reside in interstices formed by relatively larger particles providing in combination a relatively uniform coating.

The particles may be further characterized by an aspect ratio, i.e., a dimensionless ratio between the smallest dimension of the particle (H) and the longest dimension (L) or equivalent diameter (Deq) in the largest plane orthogonal to the smallest dimension, as relevant to their shape. The equivalent diameter (Deq) is defined by the arithmetical average between the longest and shortest dimensions (or width W) of that largest orthogonal plane. The availability of any particular measure may depend on the information supplied by the manufacture of the particles and/or on the method elected to assess such measures.

In any event, particles having an almost spherical shape have relatively similar longest dimension L, width W and smallest dimension H, and are therefore characterized by an aspect ratio (e.g., Asp=H/Deq or Asp=H/L, Deq and L being similar for spherical particles) of approximately 1:1. In contrast, flake-like particles can have higher aspect ratios of 1:5 or more, 1:10 or more, 1:20 or more, 1:30 or more, 1:40 or more, 1:50 or more, 1:60 or more, 1:70 or more, 1:90 or more, 1:100 or more, or even 1:200 or more. Typically, flake shaped particles, such as metallic-looking particles suitable for the present methods, kits and compositions have an average aspect ratio not exceeding 1:500, being often of 1:400 or less, or 1:300 or less. Flake shaped metallic-looking particles generally have an average aspect ratio in the range of from about 1:5 to about 1:100, or from about 1:10 to about 1:80, or from about 1:20 to about 1:60. As used herein, the term “aspect ratio” refers to an average aspect ratio (ASPavg) being the ratio between the average of the smallest dimension of the particles (Havg), which for flake shaped particles can be the average of the maximal thicknesses of the particles, and the average of the longest dimension of the particles (Lavg), which can be mathematically defined by ASPavg=Havg/Lavg. Average values can be volume-averaged values.

According to some embodiments, the plurality of particles have an average long dimension Lavg of at most 200 micrometres, at most 150 μm, at most 100 μm, at most 80 μm, at most 60 μm, at most 50 μm, at most 40 μm, at most 25 μm, at most 20 μm, at most 15 μm, at most 12 μm, at most 10 μm, at most 8 μm, at most 6 μm, at most 4 μm, at most 3 μm, at most 2 μm, at most 1.5 μm, at most 1.2 μm, at most 1.0 μm, at most 0.8 μm, at most 0.7 μm, at most 0.65 μm, or at most 0.6 μm.

According to further embodiments, the average long dimension Lavg is at least 0.04 micrometre, at least 0.05 μm, at least 0.06 μm, at least 0.08 μm, at least 0.10 μm, at least 0.12 μm, at least 0.15 μm, at least 0.20 μm, at least 0.40 μm or at least 0.60 μm.

In some embodiments, the average long dimension Lavg is the volume-averaged long dimension of the plurality of particles.

According to some embodiments, the plurality of particles have a average maximum thickness Havg of at most 1000 nanometres, at most 800 nm, at most 600 nm, at most 500 nm, at most 400 nm, at most 350 nm, at most 300 nm, or at most 250 nm. In particular embodiments, the average maximum thickness of the particles is at most 200 nm, at most 175 nm, at most 150 nm, at most 125 nm, or at most 100 nm, at most 90 nm, at most 80 nm, at most 70 nm, at most 60 nm, at most 50 nm, or at most 40 nm.

According to further embodiments, the average maximum thickness Havg is at least 5 nm, at least 7 nm, at least 10 nm, at least 15 nm, at least 20 nm, at least 25 nm, at least 30 nm, at least 40 nm, or at least 50 nm.

In some embodiments, the average maximum thickness Havg is the volume-averaged maximum of the plurality of particles.

Such characteristic dimensions are generally provided by the suppliers of such particles and can be assessed on a number of representative particles by methods known in the art, such as microscopy, including, in particular, by light microscope for particles of several microns or down to estimated dimensions of about 200 nm, by scanning electron microscope (SEM) for smaller particles having dimensions of less than 200 nm (SEM being in particular suitable for the planar dimensions) and/or by focused ion beam (FIB) (preferably for the thickness and length (long) dimensions of sub-micronic particles, also referred to herein as nanoparticles or nanosized particles). While selecting a representative particle, or a group of representative particles, that may accurately characterize the population (e.g., by diameter, longest dimension, thickness, aspect ratio and like characterizing measures of the particles), it will be appreciated that a more statistical approach may be desired. When using microscopy for particle size characterization, a field of view of the image-capturing instrument (e.g., light microscope, SEM, FIB-SEM etc.) is analyzed in its entirety. Typically, the magnification is adjusted such that at least 5 particles, at least 10 particles, at least 20 particles, or at least 50 particles are disposed within a single field of view. Naturally, the field of view should be a representative field of view as assessed by one skilled in the art of microscopic analysis.

The average value characterizing such a group of particles in such a field of view is obtained by volume averaging. In such case, D_{V}50=Σ[(Deq(m))³/m]^{1/3}, wherein m represents the number of particles in the field of view and the summation is performed over all m particles. As mentioned, when such methods are the technique of choice for the scale of the particles to be studied or in view of their media, such measurements can be referred to as D50.

According to features of some embodiments, the particles have a hydrophobic surface.

According to still further features of some embodiments, the particles are non-hydrophobic, and a hydrophobic layer is attached to each of the particles, and at least partially envelops each of the particles. The hydrophobic layer, further coating the particle to render it hydrophobic or to increase its inherent hydrophobicity, can be an inorganic hydrophobic layer (e.g., including a metal oxide) or an organic hydrophobic layer (e.g., including, mainly including, or consisting essentially of at least one of the group consisting of a fatty acid, an oil and an oily substance).

In some embodiments, the fatty acid, oil, and oily substance, which may further coat metallic-looking particles for the present teachings, have a backbone having a carbon number of at least 6, and optionally, within a range of 6 to 50, 6 to 30, 6 to 24 or 10 to 24.

The hydrophobic layer, when present through further coating of the particles, has, in some embodiments, a thickness of at most 15 nm, at most 10 nm, at most 7 nm, at most 5 nm, at most 4 nm, at most 3 nm, at most 2.5 nm, or at most 2 nm.

According to still further features of some described embodiments, the organic content of the particles, by weight, is at most 15%, at most 12%, at most 10%, at most 8%, at most 6%, or at most 4%.

In the present disclosure, the terms “dispersion”, “dispersed in” and such variations are not to be limited to any particular type of mixture of materials of same or different phase and are to be understood more broadly as any composition suitable for the present method. Hence, “carried by”, unless otherwise clear from context, can be replaced by “dispersed in”, “suspended in”, “dissolved in”, “emulsified in”, and such variations, a “carrier” being able to form dispersions, suspensions, solutions, emulsions, and any such form of compositions, as respectively appropriate.

The metallic-looking pigment particles are typically present in their carrier (aqueous or organic, as detailed for the base coat composition) in an amount of about 1 to 20% by weight of the total nail formulation, or 5 to 15 wt. %. If a content of the pigments (independent of shape) is less than 1 wt. %, the visual effect may be faint, but satisfactory if do desired. On the other hand, if present in excess of 20 wt. %, the pigments may cause a relatively high viscosity which may impair flowing and application of the formulation. As mentioned, the pigment particles can be of one type or more.

Nail formulations may comprise anti-corrosion agents, anti-foaming agents, anti-oxidants, adhesion-promoting agents, bactericides, pH buffering agents, fungicides, humectants, viscosity modifying agents, vitamins and any like agent customary in the preparation of cosmetic compositions including metallic-looking particles in the form being considered. Generally, nail formulations may further comprise such additives, even when lacking metallic-looking particles, some agents of one coat being able to peripherally protect other coats of nail formulations. For instance, anti-corrosion agents can be added to a top coat composition to “neutralize” a corrosive factor and reduce or prevent corrosion of metallic-looking particles applied as an underneath layer.

Adhesion promoting agents can be phosphate esters and hydroxyl functional film-forming polymers, for instance known to improve the adhesion of water-borne and solvent-borne coatings and inks to ferrous metal, zinc alloy and aluminum substrates. Such additives can also be used for stabilizing aluminum and other metallic-looking pigments in water-borne systems, especially for the prevention of corrosion. These materials, therefore possibly providing different advantages to the metallic-looking pigments and compositions thereof, are generally present in a weight per weight ratio of 0.05:1 to 1:1, with respect to the metallic-looking pigments.

Examples of anti-corrosion/adhesion promoting agents include, but are not limited to, Lubrizol® 2061, Lubrizol® 2062, Lubrizol® 2063, Lubrizol® 2064 and Lubrizol® 2120, commercially available from the Lubrizol® Corporation.

### Flexible Support for Metallic-Looking Particles

A flexible support able to carry metallic-looking particles, so as to release them and transfer them selectively to a base coat upon contact, is formed of a particles' receptive layer, this layer optionally attached to a body to support it. Depending on the composition of the particles' receptive layer and on its thickness, an underlying body may become necessary to provide any of the following features to the flexible support.

The particles' receptive layer and/or, when present, the body, for instance a flexible foil, are each selected to provide one or more of the following properties to the flexible support: a) sufficient flexibility to bend to follow (i.e. to closely conform) the surface of a nail substrate; b) sufficient mechanical resistance (e.g., tenaciousness and/or tensile strength) to be peeled apart from a substrate without tearing in pieces; c) sufficient mechanical stability to be peeled apart from a substrate without substantially deforming (change of shape and/or dimensions); d) sufficient adhesion to one another (e.g., of the particles' receptive layer to the body) not to split apart when peeled therewith from a substrate; e) enough compressibility to permit intimate contact between the particles' receptive layer (and the particles thereupon) and the base coat sufficient to enable transfer; and f) enough smoothness, when high gloss is desired.

Referring first to the body, numerous suitable bodies, such as thin flexible sheets made of polymers (e.g., polyethylene terephthalate (PET), polyimides, polyamides etc.), are readily available.

Particles' receptive layers, to be detailed in following sections, and body shaped as flexible foils exist in a variety of compositions, providing a wide range of surface properties, such as smoothness, hydrophobic/hydrophilic characteristics, surface energy, polarity and any such surface properties that may ultimately serve any of the manufacturing of the flexible support and the ability of the particles' receptive layer to fulfil its intended purpose as herein disclosed.

The body may be of any suitable material or combination of materials, as long as the materials are compatible with the manufacturing method. For instance, they need to sustain the curing conditions of the particles' receptive layer thereupon or any other method of attachment necessary for the preparation of the flexible-support, both in its initial bare state and once carrying the plurality of particles.

In some embodiments, the flexible body has a thickness of at least 3 micrometres, or at least 50 μm, or at least 100 μm. In some embodiments, the flexible body has a thickness of at most 1 mm, or of up to 500 μm.

A flexible support can be prepared by forming the particles' receptive layer of a flexible body, the receptive layer being applied in the form of a curable fluid. During the formation of the flexible support, the body is supported on a continuous flat support, for example, a table or the like. While in the present description the particles' receptive layer is described as being cured on top of the body, this is not essential as it may conversely be prepared by applying the body on top of the curable receptive layer. Alternatively each of the particles' receptive layer and the body can be prepared (e.g., cured) separately on a smooth surface and thereafter attached one to the other, the attachment being optionally improved by the addition of an in-between priming layer or adhesive layer. Advantageously, the bare flexible support is manufactured under controlled conditions and environment (e.g., so as to reduce dust contamination).

To ensure adequate contact between the body contact surface and the layer to be formed thereupon, as well as to ease processing, in some embodiments the surface of the body is wettable by the fluid of the curable particles' receptive layer. Having a wettable carrier contact surface advantageously improves the uniformity of the layer to be formed thereupon. Such increased wettability may also provide for or be associated with reduced surface defects, such as pin holes, “orange peel” and the like in the particles' receptive layer, which in turn could affect proper transfer to the nail substrate.

Accordingly, in some embodiments, the surface energy of the body contact surface and/or of the particles receptive layer outer surface can be between 18 and 50 mJ/m², between 18 and 25 mJ/m², or between 20 and 50 mJ/m², such values being determined with distilled water at ambient temperature (circa 23° C.).

The particles' receptive layer can comprise any elastomeric material which, when cured, has properties suitable for use with the metallic-looking particles to be carried thereupon. Such properties include chemical compatibility with the particles, the property to retain particles applied thereupon until their desired transfer to a nail substrate, and the property to release the particles upon contacting with the base coat, without tearing or splitting from the body of the flexible support, or any such phenomenon that would cause the undesired deformation of the patterns of particles being transferred.

An additional aspect for selecting a curable elastomer fluid for the formation of the particles' receptive layer relates to the adhesion of the resulting layer to the surface of the body, when present, subsequent to curing. If adhesion is insufficient, the particles' receptive layer may separate from the body during curing, during application of the metallic-looking particles, during peeling apart of the flexible support from the nail substrate, or at any other undesirable time.

In some embodiments, the particles' receptive layer comprises a silicone polymer, for example, a polydimethylsiloxane which can further include curable reactive groups. The curable reactive groups can be addition curable groups or condensation curable groups.

In some embodiments, the particles' receptive layer comprises a vinyl-functional silicone polymer, wherein the vinyl groups can be attached to the silicone backbone terminally or laterally, for example, a vinyl-terminated polydimethylsiloxane, which can additionally include one or more pendent vinyl groups.

The fluid curable particles' receptive layer can be deposited onto the body at a temperature of at least 10° C. and not more than 50° C. during the forming of the layer. In some embodiments, when addition curing is used to cure the curable elastomer, the curing temperature is at least 25° C. In some embodiments, the temperature is not more than 40° C. and even not more than 35° C. In some embodiments, depositing the layer of the curable fluid comprises pouring the fluid onto the surface of the body and levelling it to any desired thickness. In some embodiments, the curable fluid de-gases (eliminate entrapped bubbles) while levelling.

In some embodiments, the thickness of the particles' receptive layer is such that when substantially fully cured, the resulting receptive layer is not less than 2 micrometres. Depending on the presence of an optional body, a particles' receptive layer can have a thickness in the range of 400 μm to 1000 μm, if self-supported, or of at most 400 μm, or at most 200 μm, if further attached to a body. By “substantially fully cured” is meant a stage of curing is reached or passed where the layer does not undergo any further substantial change in dimensions (or in viscosity, if considering non-rigid fully cured materials).

In some embodiments, the thickness of a flexible support including a particles' receptive layer and a body is, when substantially fully cured, in the range between 100 μm and 1000 μm, or between 100 μm and 500 μm or between 100 μm and 300 μm.

In some embodiments, it is desirable that the flexible support, and particularly the particles' receptive layer, has a uniform thickness to provide superior transfer of metallic-looking particles. Accordingly, in some embodiments, the variance of thickness of the layer of applied curable fluid is such that when substantially fully cured, the variance of thickness of the resulting receptive layer is within 5 micrometres, or within 2 μm, or within 1 μm, or within 0.5 μm, or within 0.2 μm of a predetermined thickness. In some embodiments, the variance of thickness of the layer of the applied fluid first curable material is such that when substantially fully cured, the variance of thickness of the resulting release layer is within 20% of a predetermined thickness, or within 15%, or within 10%, or within 5%.

As explained, relatively smooth surfaces are preferred for glossy effects, hence a particles' receptive layer and/or a body upon which it may be formed or attached should in such cases have an average roughness Rₐ of 250 nm or less, and as detailed for the base coat.

In some embodiments, during the forming of the particles' receptive layer, the thickness of the formed layer is mechanically adjusted while the curable material is still fluid, for example, with the help of a knife, bar or roller. The skilled person knows how to select such a levelling device according to the desired thickness of the layer and/or the necessary accuracy.

The receptive layer curable fluid is cured in any suitable way, including fast curing and slow curing methods. The curing method selected may depend on the specific formulation and material used for the particles' receptive layer. By way of example, curing or its rate can be increased by applying heat to the layer, including curing accelerators, controlling curing environment (e.g., increasing moisture for condensation curable polymers) and the like.

When desired a primer or adhesive layer can be applied on the flexible support body to facilitate the attachment of the particles' receptive layer, whether applied as a curable fluid or separately preformed as a cured layer. Such priming or adhesive materials are known in the art and need not be further detailed herein. The thickness of the primer/adhesive layer, if present, can be between 0.1 and 50 μm, or between 100 nm and 5 μm. In some embodiments, at least one of the surfaces to be attached, and coated with a primer/adhesive layer, is physically pre-treated, for instance by gentle abrasion, plasma treatment etc., to facilitate the attachment.

While not essential, in some embodiments, especially in embodiments where the particles are to be applied with a predetermined shape, the body of the flexible support and the particles' receptive layer are transparent. A transparent flexible support can facilitate the desired positioning of a predetermined shape of metallic-looking particles on a nail substrate.

A surface is said to be hydrophobic when the angle formed by the meniscus at the liquid/air/solid interface, also termed wetting angle or contact angle, exceeds 90°, the reference liquid being distilled water at ambient temperature (circa 23° C.). Under such conditions, which are conventionally measured with a goniometer or a drop shape analyser and can be assessed at any given temperature and pressure (e.g., at ambient conditions, the water droplet tends to bead and does not wet the surface. Conversely, a surface is deemed hydrophilic when the contact angle is less than 90°, the water droplet readily spreading and wetting the surface. In some embodiments, the outer surface of the particles' receptive layer is hydrophobic.

In some embodiments, the particles' receptive layer has a hardness in the range of 5 Shore A to 60 Shore A.

### Top Coat

While base coat compositions mainly needs to properly wet the keratinous substrate and attach the particles applied thereto, while tacky, the top coat, when present needs to properly wet the metallized segments to form thereupon a protective coat. As this coat should not reduce the visual effect provided by the metallized region, the top coat typically includes one or more clear or transparent film-forming polymers. Advantageously, the top coat does not significantly increase the haze of the metallized region, thus has by itself no haze or a relatively low haze.

As top coats are typically to provide resistance to scratch, abrasion and any such mechanical deleterious factors, top coats are sufficiently hard to achieve such effect while not being exceedingly hard to an extent rendering the coat too brittle. In some embodiments, the clear film-forming polymers of the top coat have, once dried or cured, a hardness in the range of 40 Shore D to 90 Shore D.

In one embodiment, the clear film-forming polymers of the top coat are cellulose-based polymers selected from the group comprising nitrocellulose, cellulose acetate, cellulose acetobutyrate, cellulose acetopropionate, and ethylcellulose; polyurethanes; acrylic polymers; vinyl polymers; polyvinyl butyrals; alkyd resins; and resins derived from aldehyde condensation products such as arylsulfonamide-formaldehyde resins, for instance toluenesulfonamide-formaldehyde resin, aryl sulfonamide-epoxy resins, and ethyltosylamide resins.

The clear film-forming polymers are typically present in a top coat composition in an amount of 10 wt. % to 50 wt. % of the total top coat composition.

When appropriate, the top coat may further comprise cross-linking agents adapted to cross-link the transparent film-forming polymer and/or curing auxiliary agents. When present, in the top coat, such agents are in amounts already detailed for the base coat compositions.

In some embodiments, the surface upon which a top coat is to be applied is pre-treated before top coat application. Pre-treatment can be chemical (e.g., including a priming layer) or physical (e.g., plasma treatment).

### General Considerations Concerning the Nail Formulations

Each of the base coat and top coat are said to constitute “nail compositions” or “nail formulations”, herein used interchangeably. Any and all of the constituents of any such nail composition are compatible with one another in the formulation being considered. Moreover, any of these nail formulations is advantageously compatible with another formulation or component used in the methods taught herein. By way of example, the base coat need be compatible with the keratinous substrate upon which it can be applied and with the particles that may subsequently be applied thereto. The metallic-looking particles need to be compatible with the base coat, and the top coat, when present, needs be compatible with the particles, and so on.

One level of compatibility relates to the ability of any one of the nail formulations to sufficiently contact the underneath surface upon which they are to be applied. When considering liquids, satisfactory contact is often expressed in terms of wettability. In other words, proper wetting by a formulation (given enough time) relates to its ability to evenly spread on the surface and remain thereupon. Advantageously, during the leveling of any nail formulation, the coat has sufficient time to de-gas, so that the amount of entrapped air bubbles, if any is low enough for the development of the desired visual effect. The capacity of one formulation to wet any surface can be estimated by comparing the surface energy of the two, the formulation having a higher surface energy than the surface it is due to coat. Moreover, such kind of compatibility is readily assessable by routine experimental procedure. Wetting can, in some embodiments, be facilitated by the addition of wetting agents in the composition in need thereof.

In some embodiments, the nail formulations are not only able to wet their underneath substrate, but can also self-level thereupon. In particular embodiments, leveling agents are added to the compositions to facilitate their leveling.

Moreover, the nail formulations are to be compatible with one another, in particular when due to contact one another on a keratinous substrate. Such kind of compatibility is readily appreciated by the skilled person, and by way of example implies that the respective compositions are chemically inert with one another and not deleterious to the formation and/or effect of one another. For instance, the composition of a first layer cannot include a component that would prevent the suitable formation of a subsequent layer (e.g., inhibiting polymerization). Similarly, the composition of a subsequent layer cannot modify the structure of the previously applied layer. For instance, it cannot swell or dissolve an underlying layer, it cannot displace the metallic-looking particles in a manner detrimental to the desired visual effect, etc.

The base coat, and more typically the top coat, can further contain a colorant. In this way, a clear colored top coat applied to a metallic-looking layer formed for instance of aluminum particles may result, for example, in a gold or copper appearance, if tinted with a yellow or orange colorant.

The compositions according to the present teachings are sufficiently viscous so as to remain on the applicator and/or on the nail substrate for the duration of the application. Moreover, they need be viscous enough to stay on the substrate for the duration of the subsequent drying of the carrier or curing of the resins comprised therein, or any such step providing for sufficient fixation of the applied coat to its underneath substrate. On the other hand, the compositions should not be too viscous to an extent that would impair their readily application and/or the formation of layers having essentially an even thickness and/or a smooth surface, when applicable and desired.

The viscosity can be determined using any suitable equipment and/or standard method. In some embodiments, the viscosity can be determined at 25° C. using a Haake Mars Modular Advanced Rheometer system at a shear rate of 10 s⁻¹. Dynamic viscosity at 25° C. ranging from 10 mPa·s to 100,000 mPa·s, 10 mPa·s to 10,000 mPa·s, 50 mPa·s to 5,000 mPa·s or from to 50 mPa·s to 500 mPa·s is deemed suitable for any of the liquid compositions herein disclosed.

The compositions according to the present teachings may additionally comprise any other additive commonly used in cosmetic compositions and known to a person skilled in the art as being capable of being incorporated in a nail polish composition.

Such additives can be, by way of non-limiting examples, antifoaming agents, antioxidants, bactericides, chelating agents, dispersing agents, emulsifiers, film-forming auxiliary agents, fragrances, fungicides, fungistatic agents, humectants, leveling agents, moisturizing agents, oils, pH modifying and/or buffering agents, proteins, surfactants, preservatives, viscosity modifying agents, vitamins, waxes, spreading agents, wetting agents, neutralizing agents, stabilizing agents, surface tension controlling agents, UV screening agents, and the like, and their mixtures.

A person skilled in the art of cosmetic compositions and nail polishes knows to choose these possible additional compounds and/or their amounts so that the properties of the composition according to the invention are not, or not substantially, detrimentally affected by the envisaged addition.

Generally the nail formulations of the present disclosure may be prepared by mixing or co-grinding (e.g., for tinted base coats or top coats) most or all of the principal components in part of the carrier, so as to generate a finely ground concentrated stock of stably dispersible components. Milling can be performed under controlled conditions for any desired period of time, which for practical reasons is generally set at the first time point an homogeneous mixture satisfying any desired property (e.g., size reduction) is reached. This slurry is thereafter diluted in the appropriate carrier to any desired final concentration of a particular component. Some soluble additives can also be added at this stage. If, for instance, the component being considered of predominant importance for the suitability of an exemplary nail formulation is an organic or inorganic pigment due to tint a clear top coat, then the slurry shall be milled until the average size of the pigments (e.g., as expressed by D_{V}50) does not exceed 120 nanometres, a predominant portion of the population (e.g., as expressed by D_{V}90) preferably not exceeding 250 nm. Such dimensions facilitate the dispersibility, stability and transparency of the pigments in the top coat.

Nail formulations, when in liquid form, are generally applied to a nail substrate (or previous layers thereon) in one or more layers, until the desired visual effect is achieved. Each layer of each coat can have a thickness (in dry form) of up to about 100 μm, generally in the range from about 100 nm to about 25 μm, or from about 0.5 μm to about 10 μm. The top coat, if applied, is preferably as thin as possible, to affect gloss or any other desired visual effect as little as possible.

When metallic-looking particles are transferred from a flexible support, the resulting thickness corresponds to the thickness of the monolayer of the particles, or to a low multiple thereof (e.g., up to about 3 times Havg, and more typically, up to about 2 times Havg or up to about 1.5 times Havg).

Generally, the method of providing a metallic appearance to a nail substrate does not employ hot melt resins.

Typically, the method does not employ an adhesive.

In some embodiments, the particles are not deposited on the flexible carrier by means of a colloid.

In some embodiment, the particles are not in a colloidal formulation.

In some embodiments, the flexible carrier is not paper.

Clauses

1. A base coat for use in a method of providing a metallic appearance to a nail substrate, wherein the base coat comprises a liquid carrier and a curable film-forming polymer, wherein the base coat has a hardness in the range 10 Shore A to 90 Shore A when fully cured.

2. The base coat according to clause 1, wherein the base coat further comprises one or more of the following:
(i) a dispersant
(ii) a cross-linking agent
(iii) a curing accelerator or catalyst
(iv) a drying accelerator, and
(v) a photo-initiator.

3. The base coat according to clause 1 or clause 2, wherein the curable film-forming polymer has a Tg of 20° C. or less.

4. The base coat according to any one of clause 1 to clause 3, wherein the curable film-forming polymer is selected from the group consisting of polyurethanes; acrylic polymers; vinyl polymers; polyvinyl butyrals; alkyd resins; and resins derived from aldehyde condensation products including aryl sulfonamide-formaldehyde resins, toluenesulfonamide-formaldehyde resin, aryl sulfonamide-epoxy resins and ethyltosylamide resins.

5. The base coat according to any one of clause 1 to clause 4, wherein the cross-linking agent is present in an amount of up to 100 wt. % by weight of the polymer, or in the range between 0.01 wt. % and 20 wt. %.

6. A flexible support for use in a method of providing a metallic appearance to a nail substrate wherein the flexible support comprises a body and a particles' receptive layer.

7. The flexible support layer according to clause 6, wherein the flexible support layer has, disposed thereon, a monolayer of metallic-looking particles on at least part of the particles' receptive layer.

8. The flexible support layer according to clause 6 or clause 7, wherein the particles receptive layer is hydrophobic.

9. The flexible support layer according to clause 6 or clause 7, wherein the metallic-looking particles are made of a material selected from the group consisting of metal, alloys and oxides thereof, and core substrate coated with any of the foregoing materials, the core substrate being of a core material selected from ceramics, silicates and plastic resins.

10. The flexible support layer according to any one of clause 6 to clause 9, wherein the metallic-looking particles are flake-shaped particles having a dimensionless aspect ratio (ASPavg) between the smallest average dimension of the flakes (Havg) and the longest average dimension of the flakes (Lavg) of at least 1:5 and of at most 1:500.

11. The flexible support layer according to clause 10, wherein the longest average dimension of the flake-shaped particles (Lavg) is 200 μm or less, 50 μm or less, 10 μm or less, or 5 μm or less, and optionally, at least 0.08 μm, at least 0.12 μm, at least 0.15 μm, at least 0.2 μm, at least 0.4 μm, or at least 0.6 μm.

12. The flexible support layer according to clause 10 or clause 11, wherein the average thickness or smallest average dimension of the flake-shaped particles (Havg) is 200 nm or less, 150 nm or less, 100 nm or less, or 50 nm or less, and at least 10 nm, at least 15 nm, or at least 20 nm.

13. A top coat for use in a method of providing a metallic appearance to a nail substrate, wherein the top coat comprises a film-forming polymer, wherein the top coat has a hardness of least 40 Shore A when fully cured.

14. The top coat according to clause 13, wherein the polymer is dispersed in a liquid carrier.

15. The top coat according to clause 13 or clause 14, wherein the film-forming polymer has a Tg of 40° C. or more.

16. The top coat according to any one of clause 13 to clause 15, wherein the top coat film-forming polymer is selected from the group consisting of cellulose-based polymers selected from the group comprising nitrocellulose, cellulose acetate, cellulose acetobutyrate, cellulose acetopropionate, and ethylcellulose; acrylic polymers; vinyl polymers; polyvinyl butyrals; alkyd resins; and resins derived from aldehyde condensation products including aryl sulfonamide-formaldehyde resins, toluenesulfonamide-formaldehyde resin, aryl-sulfonamide-epoxy resins and ethyltosylamide resins.

### EXAMPLES

Aspects of the teachings herein were experimentally demonstrated.

### Materials

Materials and chemicals were purchased from various manufacturers, including:

### Metallic-Looking Pigments

Aluminum powder 6150, size reduced aluminum flakes having an average thickness of about 70 nm, an average long dimension of about 4 μm and an average aspect ratio of about 1:57, by Quanzhou Manfong Metal Powder Co., China.

AL VP 68680/G S-Flex, size reduced aluminum flakes having an average thickness of about 25 nm, an average long dimension of about 2.5 μm and an average aspect ratio of about 1:100, supplied as a dispersion of 25 wt. % in metoxypropanol or isopropyl alcohol (IPA), by Eckart Effect Pigments GmbH, Germany.

Metalure® A-61006, physical vapor deposited (PVD) aluminum pigments having an average thickness of about 25 nm, an average long dimension of about 6 μm and an average aspect ratio of about 1:240, supplied as a dispersion of 10 wt. % in butyl glycol, by Eckart Effect Pigments GmbH, Germany.

Metalure® L-51007 MA, PVD aluminum pigments having an average thickness of about 50 nm, an average long dimension of about 7 μm and an average aspect ratio of about 1:140, supplied as a dispersion of 10 wt. % in methoxy propyl acetate, by Eckart Effect Pigments GmbH, Germany.

Pyrisma® T30-20 Color Space Yellow, mica pigments coated with titanium dioxide and tin oxide having an average thickness of about 500 nm, long dimensions in the range of about 5-35 μm and an average aspect ratio in the range of about 1:10-1:70, supplied as a powder, by Merck Chemicals KGaA, Germany.

### From Allnex SA, Belgium

Additol® VXL-4951-N, a fluoro-modified silicone known as defoamer.

Additol® XL 6526, a low MW modified curable acrylic polymer known as flow and leveling additive.

Dipropylene glycol diacrylate (DPGDA; CAS No. 57472-68-1), a difunctional acrylate monomer which can be cured by UV or electron beam.

Ebecryl® 110, a low viscosity monofunctional reactive diluent.

Ebecryl® 270, Tg=−27° C., MW 1500, curable aliphatic urethane diacrylate known as a flexibilizer.

Ebecryl® 350, a copolymerisable silicone diacrylate, known as a substrate wetting and slip additive.

Ebecryl® 870, a fatty acid modified polyester hexaacrylate, known as a clear UV/e-beam-curable polymer.

ODA-N, Octyl/decyl acrylate (ODA), known as a reactive diluent.

### From Lamberti SpA, Italy:

Esacure® One, a difunctional a-hydroxy ketone, known as a photo-initiator for UV-curing.

Esacure® KIP 160, a difunctional a-hydroxy ketone, known as a photo-initiator for UV-curing.

Esacure® KTO 46, a liquid mixture of—trimethyl-benzoyl-diphenyl-phosphine-oxide—α-hydroxy ketones and benzophenone derivatives, known as a photo-initiator for UV-curing.

### From Others:

Palmitic acid (CAS No. 57-10-3) and stearic acid (CAS No. 57-11-4), by Sigma-Aldrich, USA.

Urotuf® L56-W-38, an anionic-stabilized aliphatic urethane polymer having a Tg of −4° C., presented in 38% solids in water, by Reichhold Chemicals Inc., USA.

Equipment used throughout the examples included:

Artificial nails Premier Collection Salon Standard, Acrylic False Nails by Codi, Korea.

Glass slides, 25×75 mm for microscope.

A bench-top Gloss-Haze meter by BYK-Gardner, Germany.

A UV Lamp by Fusion UV Systems, Model L06B, equipped with an H bulb (200-320 nm).

A hot air blower, by Philips, Model PHAG2000, the Netherlands.

A hardness tester, Durometer PCE-Dx-AS, by PCE Instruments, United Kingdom.

A Differential Scanning calorimeter (DSC) Q200 by TA Instruments, USA.

### Example 1

### Preparation of Exemplary Base Coat Compositions

### Base Coat Composition A

90 g DPGDA, 90 g Ebecryl® 270, 2 g Additol® VXL-4951-N, 1 g Ebecryl® 350, 1 g Additol® XL 6526 and 20 g ESACURE KTO 46 by Lamberti were manually mixed until an homogeneous base coat composition was formed. In this composition, the ratio between the difunctional acrylate monomer (DPGDA) and the flexibilizer (Ebecryl® 270) was 1:1 on a weight per weight basis.

The UV-curable polyurethane acrylate base coat of composition A was applied in a single layer with a nailbrush on an artificial nail and UV-cured for about 10 seconds. The shore hardness of the cured base coat was 35 Shore A. Tg was measured as well and found to be 4° C.

### Base Coat Composition B

Base Coat Composition B was prepared as described for Base Coat Composition A, the weight ratio of DPGDA to Ebecryl® 270 being now of 1 to 1.85, all other components being present in same amounts.

The UV-curable polyurethane acrylate base coat of composition B was applied in a single layer with a nailbrush on an artificial nail and UV-cured for about 10 seconds.

### Base Coat Composition C

Urotuf® L-56-W-38 was diluted in deionized water from 38 wt. % to 10 wt. % of solids. The diluted water-based dispersion of polyurethane base coat was sprayed over an artificial nail and dried for 10-30 sec using a hot air blower adjusted to a temperature of about 50° C.

### Example 2

### Compositions of Metallic-Looking Particles

### Metallic Composition AA

A powder of aluminium flakes manufactured by standard size reduction (Aluminum powder 6150, Lavg˜4 μm, Havg˜70 nm) was used as supplied.

### Metallic Composition AB

Aluminium flakes manufactured by standard size reduction (S-Flex, Lavg˜2.5 μm, Havg˜25 nm) were isolated from a stock dispersion by precipitating the particles by centrifugation at 7000 RPM for 8 minutes. The carrier supernatant was removed and the pellet of particles used “as is”.

### Metallic Composition AC

An aqueous dispersion of aluminium flakes manufactured by standard size reduction (S-Flex, Lavg˜2.5 μm, Havg˜25 nm) was prepared by dispersing 3 g of the pellet including the metallic-looking particles obtained for Composition AB in 7 g of deionized water.

### Metallic Composition AD

A powder of titanium dioxide and tin oxide coated mica flakes (Pyrisma T30-20 Color Space Yellow, Lavg˜5-35 μm, Havg˜500 nm) was used as supplied.

### Metallic Composition AE

A 4 wt. % aqueous dispersion of titanium dioxide and tin oxide coated mica flakes (Pyrisma® T30-20 Color Space Yellow, Lavg≣5-35 μm, Havg˜500 nm) was prepared by dispersing 4 g of Composition AD in 96 g deionized water.

### Flexible Supports:

Bare flexible supports were prepared by pouring and levelling on a PET support (having a thickness of 100 um and a Rₐ of 20 nm, by Dupont) a particle receptive composition as described in Table 1.

TABLE 1

| Type | Material | Supplier | CAS No. | Weight (g) |
|---|---|---|---|---|
| Vinyl silicone | DMS-V35 | Gelest | 68083-19-2 | 70 |
| Vinyl silicone | XP RV 5000 | Evonik | | 30 |
| Vinyl silicone | VQM-146 | Gelest | 68584-83-8 | 40 |
| | Inhibitor 600 | Evonik | 78-27-3 | 4 |
| platinum catalyst | SIP 6831.2 | Gelest | 68478-92-2 | 0.1 |
| Hydride Silicone | HMS 301 | Gelest | 68037-59-2 | 12 |

The particles' receptive layer was prepared at two thicknesses, of a) 200 μm (the layer being subsequently detached from the PET to serve as self-supported flexible support); and b) 400 82 m (the layer being further attached to the PET flexible body).

The particles' receptive layer was attached to the PET body support via a priming layer, previously allowed to dry for 15 minutes at ambient temperature, the priming layer having the composition provided in Table 2.

TABLE 2

| Material | Supplier | CAS No. | Weight (g) |
|---|---|---|---|
| Dynasylan VTMO | Evonik | 2768-02-7 | 2.5 |
| N-propyl silicate | ColCoat | 682-01-9 | 2.5 |
| Titanate AKT855 | Gelest | 17927-72-9 | 5 |
| SIP 6831.2 | Gelest | 68478-92-2 | 2.5 |
| Methanol | Sigma | 67-57-1 | 87.5 |

The particles' receptive layer was cured for 1 hour at 120° C. in a Heraeus, UT12, digitally controllable oven. Following curing, the particles' receptive layer was covered with a protective film to reduce undesired dusting. The protective film was removed before applying the desired metallic-looking particles as follows.

### Flexible Support BA

A flexible support bearing aluminium flakes manufactured by standard size reduction (Aluminum powder 6150, Lavg˜4 μm, Havg˜70 nm) was prepared by rubbing with a soft cloth powder composition AA on a bare flexible support having as particle receptive surface a layer of 400 μm of a particle receptive composition of Table 1 attached to a 100 μm PET body through a priming layer of Table 2 (applied at a thickness of about 1 μm).

Once the particles were sufficiently rubbed to form a continuous layer of burnished particles on the flexible support, excess particles were removed by extensive rinsing with tap water at ambient temperature. Excess water was dried with a hot hair blower. This method resulted in the preparation of flexible supports bearing metallic-looking particles substantially forming a monolayer.

### Flexible Support BB

A flexible support bearing aluminium flakes manufactured by standard size reduction (S-Flex, Lavg˜2.5 μm, Havg˜25 nm) was similarly prepared by replacing powder composition AA, by dispersion composition AC.

### Flexible Support BC

A flexible support bearing titanium dioxide and tin oxide coated mica flakes (Pyrisma® T30-20 Color Space Yellow, Lavg˜5-35 μm, Havg˜500 nm) was similarly prepared by replacing powder composition AA, by powder composition AD.

### Example 3

### Metallization of a Cured Base Coat

### Comparative Example 3A: Applications of Metallic-Looking Particles in Dispersions or Powder Forms

To base coat A and base coat B, prepared as described in Example 1, and cured on an artificial nail substrate for 10 seconds, were applied (using a soft cloth) compositions AA, AC, AD and AE of metallic-looking particles prepared as described in Example 2. The particles of the various compositions were further burnished on the surface of the nail substrate by continuous rubbing with the soft-cloth applicator until satisfactory metallic appearance was obtained. Excess particles were removed under running tap water and the metallized surfaces dried with a hot air blower. Similarly, compositions AA, AC and AD of metallic-looking particles were applied to base coat C and burnished thereupon.

### Example 3B

### Applications of Metallic-Looking Particles from a Flexible Support

To base coat A, base coat B and base coat C prepared as described in Example 1 and cured on an artificial nail for 10 seconds, were applied metallic-looking particles carried by flexible supports prepared as described in Example 2. The back side of the flexible supports was gently rubbed with a soft-cloth until particles transferred to the base coat. The transferred particles did not require rinsing or drying.

All coats of metallic-looking particles formed on top of the base coats of the present study displayed stable attachment to their underneath layer, and did not unintentionally transfer through contact to other surfaces.

### Example 4

### Top Coat Compositions

A UV-curable top coat was prepared by mixing 50 g of Ebecryl® 870 (fatty acid modified polyester hexaacrylate), 50 g of ODA (reactive diluent), 5 g of Esacure® KTO-46 (photo-initiator). (Top Coat CA)

Top Coat CB was prepared by replacing the ODA diluent of Top Coat CA by Ebecryl® 110.

A commercially available top coat (Zapon Varnish, Cat. No. 10026, AkzoNobel) was used for comparison. (Top Coat CC)

Tinted top coat compositions were prepared as follows. 45 g of pigment, 112.5 g of dispersant (Bykjet® 9132), 142.5 g of solvent (PGMEA) were put in Attritor S0 (Union Process) filled with 3.3 kg of stainless steel media (Union Process) having a diameter of about 0.24 cm for a duration of time and at an energy input sufficient to prepare slurries comprising pigment particles having a D_{V}50 of 100 nm or less (as assessed by DLS using Malvern Zetasizer Nano ZS). The stainless steel beads were allowed to separate by gravitation and the pigment slurries were collected.

The pigments size reduced by this method included Pigment Yellow 139 (Paliotol® Yellow D 1819, BASF) and Pigment Red 81:2 (Fanal® Pink D 4830, BASF), respectively milled to D_{V}50 of about 40 nm and 30 nm.

4 g of the pigment slurry were dispersed with 26 g of commercially available Zapon Varnish to prepare tinted top coats including a 2% pigment dispersion, a yellow tinted one (Top Coat CD) and a red tinted one (Top Coat CE).

The tinted top coats prepared as above-described were applied over coats of metallic-looking particles prepared as previously described and provided the tint of their respective nanosized pigments, without affecting the transparency of the top coat, hence maintaining the metallic appearance.

### Example 5

### Assessment of Metallic Appearance

The metallic appearance of metallized regions prepared by using one or more of the coats or compositions described in previous Examples was assessed ex situ on an IPA cleaned glass slide. Instead of applying the base coat on a curved nail substrate, this first layer was applied on a flat standard microscope glass slides (25 mm×75 mm) at a thickness of about 12 μm. When desired the glass slide was first pre-coated with the priming layer of Table 2 to further the attachment of the base coat to the glass substrate. The base coat (optionally on a priming layer) was cured under conditions similar to those detailed for a nail substrate and subsequent layers also applied as described. The gloss and haze of dry metallic coats were assessed by placing the glass slide under study in the sample holder of a haze-gloss meter operated with incident light at 20° from the normal of the surface of the glass slide upon which particles were applied.

Measurements were made on at least three samples or three distinct regions of a sample. Average results rounded up to closest gloss unit or haze unit, as appropriate, are reported in Table 3. Haze values are based on logarithmic analysis.

TABLE 3

| Item No. | Base Coat | Metal Coat | Top Coat | Gloss | Haze |
|---|---|---|---|---|---|
| 1 | A | AC | None | 895 | 123 |
| 2 | A | AC | None | 836 | 86 |
| 3 | A | AC | CA | 738 | 93 |
| 4 | A | AC | CB | 684 | 84 |
| 5 | A | AC | CC | 605 | 134 |
| 6 | A | BB | None | 900 | 100 |
| 7 | C | AA | None | 600 | 400 |
| 8 | C | AD | None | 260 | 230 |
| 9 | C | BA | None | 520 | 550 |

As can be seen from the above table, methods and compositions according to present teachings provide for metallized regions having a relatively high gloss. For reference, the gloss and haze of the sole glass slide background, whether or not coated with the base coats which did not significantly modified the baseline values, were of about 160 gloss units and about 35 haze units.

Items 1 and 2 represent independent repeats of measurements on different glass slides of a same sample and show the repeatability of the method. Items 3-5 show how the application of a top coat may slightly reduce the gloss of the metallized regions by about 15 to 30% depending on the top coat. Nevertheless, the gloss of the top coated segments is still high and above at least 600 gloss units. Item 6, prepared on the same base coat (A) as items 1-5, was obtained by applying particles carried by a flexible support (BB) and displayed a very high gloss of about 900 gloss units, comparable to items 1-2, similarly lacking a top coat. This result demonstrates the feasibility of this novel mode of application, and confirms the visually assessed satisfactory transfer of particles from their receptive layer on the flexible support to the base coat.

Items 7-8, were prepared on a different base coat (C). The difference between item 7 and item 8 resides in the pigment powder being applied. While item 7 was prepared with relatively thin aluminium flakes having Lavg˜4 μm and Havg˜70 nm, item 8 was prepared with relatively thick mica coated flakes having Lavg˜5-35 μm and Havg˜500 nm. The gloss measured for item 7 is about 2.3-times higher than the gloss of item 8, which is not unexpected in view of the differences in thicknesses (about 7-fold) and the relative ease of thinner flakes to conform to the surface of a substrate.

As in the previous series, the gloss obtained following application of particles carried by a flexible support is comparable to the gloss obtained by direct application of the particles to the nail substrate (see item 9 and item 7, respectively) This result further confirms the suitability of this “indirect” mode of application of particles, via an intermediate flexible support.

### Example 6

### Selectivity of Metallic Appearance

One of the main drawbacks of conventional methods aimed to impart a metallic appearance to nail substrates is the length or complexity of the process. Moreover, when commercially available powders are applied on typical base coats, such applications are often non-specific to the nail surface, such that powder disadvantageously adheres to various surrounding surfaces (skin of the fingers, clothes, etc.).

A commercially available base coat (“IBD bond” by American International Industries, USA) was applied on half of an artificial nail substrate and UV-cured for 2 minutes. Then, an additional layer of a commercially available gel polish (“Get It” by A11, UK) was applied over the base coat and cured for an additional 2 minutes. Commercially available metallic looking powder (“Mirror Chrome no.3” by Daily Charmes, USA) was gently rubbed over the nail substrate, predominantly over the area bearing the cured layers. Then the nail substrate was rinsed with tap water to remove excess powder. However, residual powder was still visible in unintended areas lacking the base coat when using conventional metallic looking particles. A similar experiment was performed on the nails of a volunteer and in this case the non-specific attachment of the commercially available powder was also observed on the finger skin surrounding the nail, which became “metallized”.

Similar experiments were performed according to some embodiments of the present teachings. Namely, base coat B was applied on half of an artificial nail substrate and was UV cured for a few seconds until dry to the touch. A flexible support BB carrying metallic looking particles was applied on the nail substrate (particles facing the substrate) and gently rubbed thereupon, predominantly over the area bearing the cured base coat. The flexible support was peeled away from the nail to selectively leave on the base coat area a metallic appearance as previously described. No particles could be visually detected in the unintended areas of the nail (devoid of the base coat), obviating the need for a tap water rinse. A similar experiment was performed on the nails of a volunteer, and again, no non-specific attachment of particles could be visually observed on the finger skin surrounding the nail. This example establishes the advantageous selectivity of a method according to the present disclosure towards desired areas of the nail substrate accordingly pre-coated with a base coat. In other words, the present method provides a relatively clean process for the metallization of keratinous substrates.

The commercially available powder and particles used in the present example were subjected to similar analysis to gain comparable parameters. This analysis included, when microscopic analysis (top view and cross-section view by FIB microscopy—CROSSBEAM 340 of Zeiss) and the results obtained from averaging the sizes of at least 5 particles in a representative field of view or the size ranges deduced from at least 10 particles (for heterogeneous population) are reported in Table 4 below.

TABLE 4

| | | |
|---|---|---|
| Item No. | Powder | Particles |

| | | | | |
|---|---|---|---|---|
| L_{Avg} | 9-207 | μm | 0.1-4 μm | (Avg ~2.5 μm) |
| H_{Avg} | 0.65-4 | μm | 10-85 nm | (Avg ~25 nm) |

| | | |
|---|---|---|
| ASP_{Avg} | 1:14-1:52 | 1:47-1:100 |

It is believed that manufacturers of metallic powders for the purpose of nail “metallization” are aware of the health concerns associated with particles in the sub-micronic range. Such apprehensions are particularly acute when such nano-particles can be airborne, as could be the case when rubbing a powder, and/or when such nano-particles can contact tissues that may not completely bar their entry into the systemic circulation of the living subject (person). Such fears may be alleviated by some embodiments of the present teachings, since particles carried by a flexible support and selectively transferred therefrom and adhered to a base coat would have little opportunity to become airborne and would not unintentionally attach to the nail substrate in the absence of a base coat or to the surrounding finger skin.

It is additionally believed that a metallic appearance can be achieved by the present methods while using relatively less metallic materials than conventional methods. Without wishing to be bound to any particular theory, it is assumed that the relatively small thickness of particles as used herein allows the particles to more easily follow the contour of the keratinous substrate with respect to conventional particles. Thus, a given weight amount of relatively thin particles may provide at least the same, if not superior, metallic appearance relative to the same weight amount of relatively thick particles. Moreover, as the thin particles used in an embodiment of the present invention may form on the flexible support a layer which can be substantially a monolayer, such arrangement further reduces the amount of metallic materials required to achieve a particular metallic appearance. Reducing the amount of metallic materials necessary to achieve any desired “metallization” may be advantageous, for instance, for reducing the costs associated with such components and also for reducing the exposure to such materials.

In the description and claims of the present disclosure, each of the verbs, “comprise” “include” and “have”, and conjugates thereof, are used to indicate that the object or objects of the verb are not necessarily a complete listing of members, components, elements, steps or parts of the subject or subjects of the verb.

As used herein, the singular form “a”, “an” and “the” include plural references and mean “at least one” or “one or more” unless the context clearly dictates otherwise.

Positional or motional terms such as “upper”, “lower”, “right”, “left”, “bottom”, “below”, “lowered”, “low”, “top”, “above”, “elevated”, “high”, “vertical”, “horizontal”, “front”, “back”, “backward”, “forward”, “upstream” and “downstream”, as well as grammatical variations thereof, may be used herein for exemplary purposes only, to illustrate the relative positioning, placement or displacement of certain components, to indicate a first and a second component in present illustrations or to do both. Such terms do not necessarily indicate that, for example, a “bottom” component is below a “top” component, as such directions, components or both may be flipped, rotated, moved in space, placed in a diagonal orientation or position, placed horizontally or vertically, or similarly modified.

Unless otherwise stated, the use of the expression “and/or” between the last two members of a list of options for selection indicates that a selection of one or more of the listed options is appropriate and may be made.

In the disclosure, unless otherwise stated, adjectives such as “substantially” and “about” that modify a condition or relationship characteristic of a feature or features of an embodiment of the present technology, are to be understood to mean that the condition or characteristic is defined to within tolerances that are acceptable for operation of the embodiment for an application for which it is intended, or within variations expected from the measurement being performed and/or from the measuring instrument being used. When the term “about” precedes a numerical value, it is intended to indicate +/−15%, or +/−10%, or even only +/−5%, and in some instances the precise value.

While this disclosure has been described in terms of certain embodiments and generally associated methods, alterations and permutations of the embodiments and methods will be apparent to those skilled in the art. The present disclosure is to be understood as not limited by the specific embodiments described herein.

Certain marks referenced herein may be common law or registered trademarks of third parties. Use of these marks is by way of example and shall not be construed as descriptive or limit the scope of this disclosure to material associated only with such marks.

1. A method of providing a metallic appearance to a nail substrate, the method comprising:
a) applying a base coat to at least part of an outer surface of the nail substrate;
b) providing a flexible support having disposed, on a surface thereof, a monolayer of metallic-looking particles of at least one metallic-looking pigment; and
c) transferring the monolayer from the flexible support to an outer surface of the applied base coat, so as to form a coat of metallic-looking particles on the nail substrate.

2. The method according to claim 1, wherein the metallic appearance of the metallic-looking particles transferred from to the base coat has a gloss value of 100 gloss units or more as measured at 20° from normal of said transferred particles.

3. The method according to claim 2, wherein said gloss value is within a range of 100 to 1800 gloss units.

4. The method according to claim 1, wherein said transferring is effected by contacting said monolayer with said outer surface and applying a relative pressure between the flexible support and the nail substrate.

5. The method according to claim 1, wherein said monolayer is disposed on an entirety of said surface of the flexible support or as a predetermined pattern on said surface of the flexible support.

6. (canceled)

7. The method according to claim 1, wherein said surface of the flexible support includes a hydrophobic particle receptive surface.

8. The method according to claim 1, the method further comprising applying a top coat to said outer surface of the applied base coat so as to completely cover said monolayer.

9. The method according to claim 1, wherein the base coat consists of a curable film-forming polymer, the curable film-forming polymer adapted such that, upon full curing of the base coat, the base coat achieves a hardness of at least 10 Shore A and at most 90 Shore A.

10. The method according to claim 9 wherein the curable film-forming polymer is selected from the group consisting of polyurethanes; acrylic polymers; vinyl polymers; polyvinyl butyrals; alkyd resins; and resins derived from aldehyde condensation products including arylsulfonamide-formaldehyde resins, toluenesulfonamide-formaldehyde resin, arylsulfonamide-epoxy resins and ethyltosylamide resins.

11. The method according to claim , wherein the base coat further comprises a cross-linking agent.

12. The method according to claim 9, wherein the base coat further comprises a curing auxiliary, the curing auxiliary being at least one of a drying accelerator, a photo-initiator, a UV-curing accelerator and a UV-curing catalyst.

13. The method according to claim 1, wherein the particles are made of a material selected from the group consisting of metal, alloys and oxides thereof, and core substrate coated with any of the foregoing materials, the core substrate being of a core material selected from ceramics, silicates and plastic resins.

14. The method according to claim 1, wherein the particles are flake-shaped particles having a dimensionless aspect ratio (ASPavg) between the smallest average dimension of the flakes (Havg) and the longest average dimension of the flakes (Lavg) of at least 1:5 and of at most 1:500.

15. The method according to claim 14, wherein the longest average dimension of the flake-shaped particles (Lavg) is 200 μm or less and at least 0.08 μm , at least 0.12 um, at least and wherein the average thickness or smallest average dimension of the flake-shaped particles (Havg) is 200 nm or less and at least 10 nm.

16. (canceled)

17. The method according to claim 1, wherein the top coat, if applied, consists of a top coat film-forming polymer having a Tg of 40° C. or more, the film-forming polymer adapted such that, upon full curing of the top coat, the top coat achieves a hardness of at least 40 Shore D.

18. The method according to claim 17, wherein the top coat film-forming polymer is selected from the group consisting of cellulose-based polymers selected from the group comprising nitrocellulose, cellulose acetate, cellulose acetobutyrate, cellulose acetopropionate, and ethylcellulose; acrylic polymers; vinyl polymers; polyvinyl butyrals; alkyd resins; and resins derived from aldehyde condensation products including arylsulfonamide-formaldehyde resins, toluenesulfonamide-formaldehyde resin, aryl-sulfonamide-epoxy resins and ethyltosylamide resins.

19. The method according to claim 1, wherein at least one of the base coat and the top coat is tinted, so as to further provide a background and/or a foreground tint, respectively, to the metallic appearance.

20. The method according to claim 1, wherein said applying said base coat is performed solely on a portion of said outer surface of the nail substrate.

21. The method according to claim 1, wherein said applying said base coat is performed on an entirety of said outer surface of the nail substrate.

22. The method according to claim 1, further comprising curing any one of the applied coats, said curing being selected from dry curing, air-flow curing, heat curing, UV-curing, visible light curing and e-beam curing.

23.-37. (canceled)
